(19) United States
(12) Patent Application Publication
(10) Pub. No.: US 2025/0206851 A1
(43) Pub. Date: Jun. 26, 2025

(54) Conversion Of Biomass To Functional Micro- And Nano-Structured Materials For Sustainable Element Recovery

(71) Applicant: The Penn State Research Foundation, University Park, PA (US)

(72) Inventors: Amir Skeikhi, University Park, PA (US); Mica L. Pitcher, University Park, PA (US)

(21) Appl. No.: 18/847,619

(22) PCT Filed: Mar. 8, 2023
(86) PCT No.: PCT/US2023/063928

§ 371 Date: Sep. 16, 2024

Related U.S. Application Data
(60) Provisional application No. 63/321,924, filed on Mar. 21, 2022.

(51) Int. Cl. C08B 37/00

(52) U.S. Cl. CPC C08B 37/00

(57) ABSTRACT

Embodiments relate to a method of forming a precipitate. The method involves a multi-step chemical conversion of biomass with an oxidant to convert a hydroxyl group of the biomass into an aldehyde group. One embodiment can use sodium chlorite as the oxidant and form a micro- and/or nano-structured precipitate with the sodium chlorite-oxidized biomass, the micro- and/or nano-structured precipitate having a charge density equal to or greater than 0.01 mmol g⁻¹. The method is applicable to all carbohydrates and also polyphenolic compounds. The method may result anionic, cationic, zwitterionic, and/or electrically neutral micro and/or nanoscale products. Macroscale products may also be yielded.

### CROSS-REFERENCE TO RELATED APPLICATIONS

This patent application is related to and claims the benefit of U.S. provisional patent application 63/321,924, filed on Mar. 21, 2022, the entire contents of which is incorporated by reference.

### FIELD OF THE INVENTION

Embodiments relate to a sequential oxidation method that can be applied to a biomass to generate fractions of biocolloids and microproducts bearing anionic groups with a concentration of up to 6 mmol g⁻¹. The sequential oxidation method can be applied to both delignified (e.g., softwood pulp and cotton) and untreated (e.g., corncob and tomato peel) lignocellulosic sources. The methods can also be applied to any other carbohydrates, such as alginate, hyaluronic acid, chitin, chitosan, etc. The oxidation may be conducted without or with any other strong or weak acids or bases. In addition, this process may be conducted with or without any external mechanical forces, such as mixing, centrifugation, fluidization, etc. This method can also be applied to non-polysaccharide materials, such as lignin. The products can be anionic, cationic, zwitterionic, or electrically neutral.

### BACKGROUND OF THE INVENTION

Rapidly growing concerns about petroleum-derived materials and the state of the climate and environment have prompted increasing research on renewable materials. Biomass, including wood, crops, grass, and their wastes, is the largest renewable organic carbon source on Earth, and therefore the best candidate for the production of advanced sustainable materials. Specifically, lignocellulosic biomass originating from agricultural wastes, such as forest residues including pine, switchgrass, and poplar, comprises more than 90% of all plant biomass and is the most abundant renewable feedstock that does not compromise global food security. The three major components of lignocellulosic biomass are cellulose (40-60%), hemicelluloses (10-40%), and lignin (15-30%). Despite a majority of research focusing on the degradation of biomass into simple sugars and small lignin aromatics, the production of value-added micro- and nanomaterials from biomass has recently attained significant potential for sustainable development.

Nanocelluloses are among the most studied biomass-based nanomaterials. They have emerged in the last decade as a class of sustainable materials for packaging, polymer composites, optoelectronics, drug delivery, tissue scaffolds, catalysis, energy storage, and environmental remediation. The two most well-known forms of nanocelluloses, cellulose nanocrystals (CNC) and cellulose nanofibrils (CNF), have many attractive properties, such as high strength and stiffness, high aspect ratio, and significant capabilities for functionalization. Some forms of nanocelluloses, named hairy cellulose nanocrystals (HCNC), can be synthesized, which offer a new range of attractive properties compared with conventional nanocelluloses, such as high functional group density and a unique hairy structure.

### SUMMARY OF THE INVENTION

HCNC have been produced via the sequential oxidation of softwood pulp. The disordered regions of fibrils are preferentially oxidized and cleaved, with the remaining portion attached to the crystalline regions, enabling the “hairy” structure of HCNC. Conventional CNC are typically formed through strong acid hydrolysis and complete elimination of the disordered regions of fibrils, resulting in highly crystalline rod-like nanocrystals. Contrastingly, HCNC contain partially preserved disordered cellulose. Oxidation with sodium periodate results in oxidative cleavage of the vicinal diol at the C2-C3 bond on cellobiose, the repeating unit of cellulose chains, to form dialdehyde modified cellulose (DAMC). Several reactions of DAMC enable the formation of HCNC with electrically neutral, cationic, or anionic groups. Subsequent oxidation of DAMC with sodium chlorite selectively converts the aldehyde groups to carboxylate groups, which disintegrates the DAMC to nanocrystals as electrostatic repulsion among the crystals is increased. This yields anionic HCNC (AHCNC), which comprises a crystalline body similar to that of conventional CNC, sandwiched between highly negatively charged disordered cellulose chains. The acid-free serial oxidation procedure enables AHCNC to bear more than 6 mmol of charged groups per gram of material, while the maximum charge content of CNC is typically less than 1.5 mmol g⁻¹.

Lignin nanoparticles (LNP) are another biomass-based nanomaterial with great interest because of lignin's recalcitrance and complexity. The highest charge group density reported for LNP is about 1.75 mmol g⁻¹. While the applications of biocolloids in water treatment and element recovery necessitates a high charge group density, chemical structure of lignocellulosic sources decorated with electrically neutral groups as well as the lack of functionalizability of inner crystalline layers have significantly limited their maximum charge group density. Accordingly, there is an unmet need for a universal and facile method to convert lignocellulosic biomass to an array of highly charged micro- and nanomaterials.

Embodiments disclosed methods resulting from evaluating the universality of the sequential acid-free periodate/chlorite-mediated conversion of lignocellulosic biomass to highly-charged micro- and nanostructured materials. Four lignocellulosic sources with a wide range of biopolymer compositions and physicochemical properties were investigated. Softwood and cotton were selected as treated cellulosic sources, almost free from lignin and hemicelluloses, with well-described differences in content of disordered and crystalline cellulose. Corncob and tomato peel were selected as raw, untreated, lignocellulosic sources to encompass a wide range of polysaccharide concentrations. Each source is subjected to subsequent periodate and chlorite oxidation, and the physicochemical properties of the products were thoroughly characterized. As a proof-of-concept, one of these novel biomass-based materials is used for the low concentration removal and recovery of a rare-earth element (REE), neodymium, from aqueous media.

Embodiments can relate to a method of forming a precipitate. The method can involve oxidizing a biomass with sodium periodate (NaIO₄) to convert a hydroxyl group of the biomass into an aldehyde group. The method can involve oxidizing the sodium periodate-oxidized biomass with sodium chlorite (NaClO₂) to convert the aldehyde group to a carboxylate group. The method can involve forming a micro- and/or nano-structured precipitate with the sodium chlorite-oxidized biomass, the micro- and/or nano-structured precipitate having a charge density equal to or greater than 0.01 mmol g⁻¹. The method can also include converting the biomass to cationic (e.g., amine or ammonium functionalized) nanoparticles or microparticles via replacing the second step oxidation with other reactants, such as Girard's reagent T.

In some embodiments, the micro- and/or nano-structured precipitate can have a charge density equal to or less than 7.0 mmol g⁻¹.

In some embodiments, the charge density can be due to the micro- and/or nano-structured precipitate including anionic groups with a concentration between a range of equal to or greater than 0.01 mmol g⁻¹ and equal to or less than 7.0 mmol g⁻¹.

In some embodiments, the biomass can be a lignocellulosic material.

In some embodiments, the lignocellulosic material can include softwood pulp, cotton, corncob, and/or tomato peel.

In some embodiments, NaIO₄ oxidation can generate oxidative cleavage of vicinal diol at the C2-C3 bond on cellobiose.

In some embodiments, generating oxidative cleavage of vicinal diol can break the C2-C3 bond while oxidizing the hydroxyl group.

In some embodiments, the micro- and/or nano-structured precipitate can include micro- or nano-particles or micro- or nano-crystals.

In some embodiments, the method can involve quenching NaIO₄ oxidation.

In some embodiments, quenching the NaIO₄ oxidation can be done by subjecting unreacted NaIO₄ to ethylene glycol.

In some embodiments, oxidizing the biomass with NaIO₄ can form a solid aldehyde-functionalized product. The method can involve isolating the solid aldehyde-functionalized product via a filtering technique.

In some embodiments, oxidizing the sodium periodate-oxidized biomass with NaClO₂ can involve subjecting the solid aldehyde-functionalized product to NaClO₂.

In some embodiments, the method can involve subjecting the sodium periodate-oxidized biomass to a hypochlorous acid (HOCl) scavenger during the step of oxidizing the sodium periodate-oxidized biomass with NaClO₂.

In some embodiments, the HOCl scavenger can be hydrogen peroxide.

In some embodiments, forming the micro- and/or nano-structured precipitate can involve centrifugation to isolate the precipitate.

In some embodiments, forming the micro- and/or nano-structured precipitate can involve centrifugation and exposure to a poor solvent to isolate the precipitate.

In some embodiments, the poor solvent can be EtOH.

Further features, aspects, objects, advantages, and possible applications of the present invention will become apparent from a study of the exemplary embodiments and examples described below, in combination with the Figures, and the appended claims.

### BRIEF DESCRIPTION OF THE DRAWINGS

The above and other objects, aspects, features, advantages and possible applications of the present innovation will be more apparent from the following more particular description thereof, presented in conjunction with the following drawings. Like reference numbers used in the drawings may identify like components.

FIG. 1A shows and exemplary method for generating an embodiment of the precipitate. FIG. 1B shows a schematic of periodate-chlorite oxidation of lignocellulosic sources. FIG. 1C shows four lignocellulosic sources and their approximate biopolymer composition. FIG. 1D shows chemical structure of lignocellulosic biopolymers and their oxidation reactions with periodate and chlorite.

FIG. 2A shows a schematic of dialdehyde modification of lignocellulosic sources and images of each source without any treatment, after soaking in water, and after periodate oxidation (left to right). FIG. 2B shows a schematic of hydroxylamine hydrochloride titration to measure the aldehyde contents for each dialdehyde-modified lignocellulosic product. FIG. 2C shows a representative titration curve of dialdehyde-modified cellulose from the softwood kraft pulp. FIG. 2D shows aldehyde content of dialdehyde-modified lignocellulosic sources. All chemical syntheses were conducted in triplicate.

FIG. 3A shows a schematic of dicarboxylate modification of dialdehyde-modified lignocellulosic sources via chlorite oxidation. FIG. 3B shows optical images of lignocellulosic sources before and after oxidation with chlorite. FIG. 3C shows a schematic of poor solvent-mediated precipitation to separate the BNP from the SB. FIG. 3D shows a schematic of the conductometric titration for measuring the carboxylate group content of products. FIG. 3E shows images of the three products obtained from the periodate-chlorite oxidation of lignocellulosic sources, followed by precipitation. The precipitated products are outlined as a guide to the eye.

FIG. 4A shows representative data for the precipitated mass of softwood pulp BNP (AHCNC) and SB (DCC) versus poor solvent (EtOH) concentration. FIG. 4B shows production yield of MP, BNP, and SB based on the mass fraction for the lignocellulosic sources. FIG. 4C shows representative conductometric titration curve of softwood kraft pulp BNP (AHCNC). FIG. 4D shows carboxylate contents of the three products for four lignocellulosic sources.

FIG. 5A shows XRD patterns of the lignocellulosic sources prior to any treatment. FIG. 5B shows the crystallinity index (CI) of initial lignocellulosic sources, MP, and BNP for each source. FIG. 5C shows representative pH change and NaOH addition (mol/mol aldehyde) during the chlorite oxidation of softwood DAMC, demonstrating the reaction kinetics. FIG. 5D shows conversion of aldehyde groups to carboxylate groups for each lignocellulosic source during chlorite oxidation, and the effective reaction time (trxn), defined as the time required to stabilize pH at 5. FIG. 5E shows FTIR spectra of each source (darker colors) and their BNP products (lighter colors).

FIG. 6A shows AFM images of BNP synthesized from the lignocellulosic sources. FIG. 6B shows optical microscopy images of lignocellulosic sources prior to oxidation. FIG. 6C shows optical microscopy images of MP following the chlorite oxidation of dialdehyde-modified lignocellulosic sources.

FIG. 7A shows a schematic of neodymium ion (Nd³⁺) removal and recovery using carboxylated cotton MP produced via the periodate and chlorite oxidation of cotton filter paper. FIG. 7B shows optical microscopy images of supernatant and adsorbent after Nd3 adsorption or recovery. FIG. 7C shows Nd³⁺ removal capacity of carboxylated cotton MP versus contact time. FIG. 7D shows Nd³⁺ removal percent versus the initial Nd³⁺ concentration (C₀). FIG. 7E shows recovery of Nd³⁺ from cotton MP after absorption via rinsing with water, followed by lowering the pH.

FIG. 8 shows an exemplary two-step, acid-free oxidation procedure that can be used for embodiments of the present invention.

### DETAILED DESCRIPTION OF THE INVENTION

The following description is of exemplary embodiments that are presently contemplated for carrying out the present invention. This description is not to be taken in a limiting sense, but is made merely for the purpose of describing the general principles and features of the present invention. The scope of the present invention is not limited by this description.

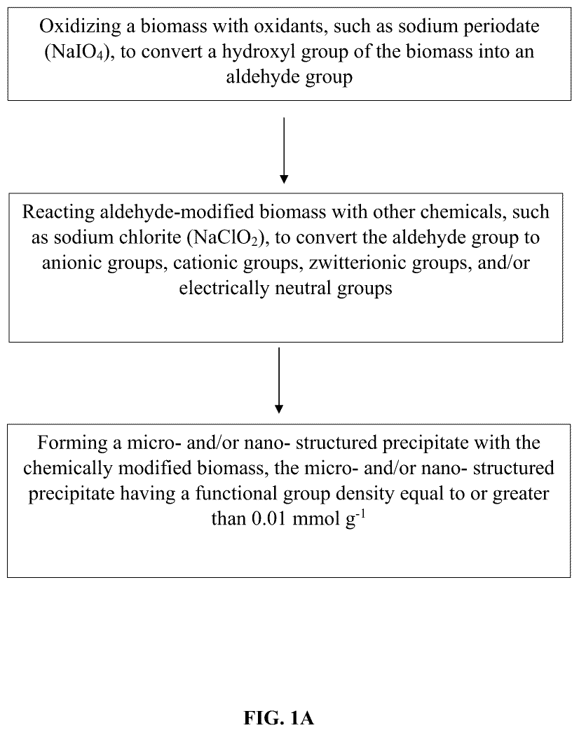

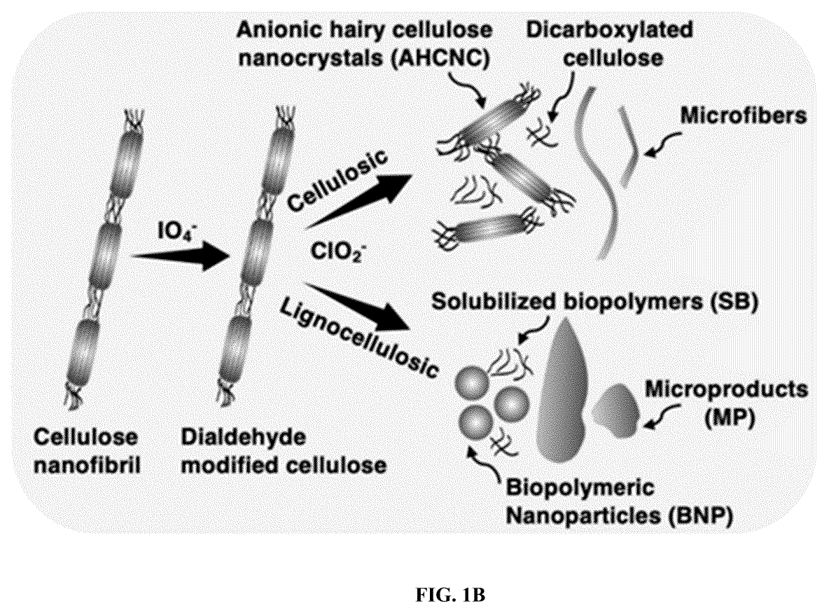

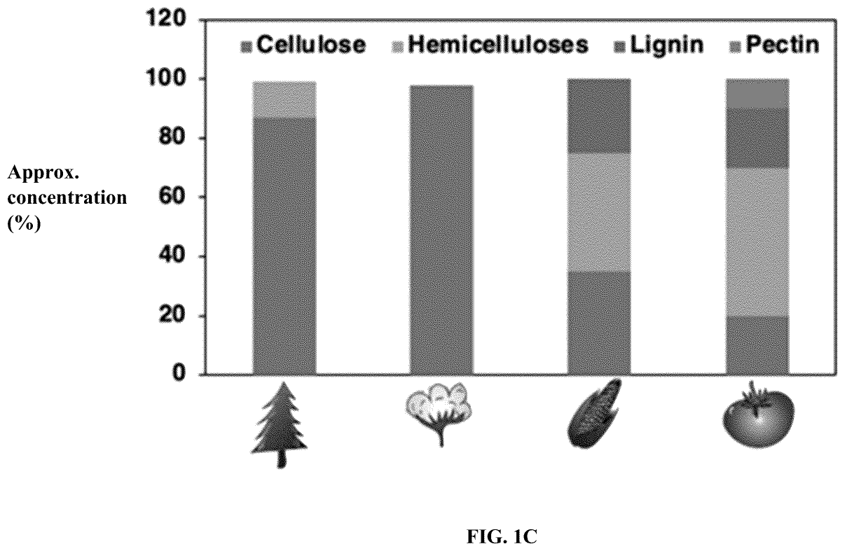

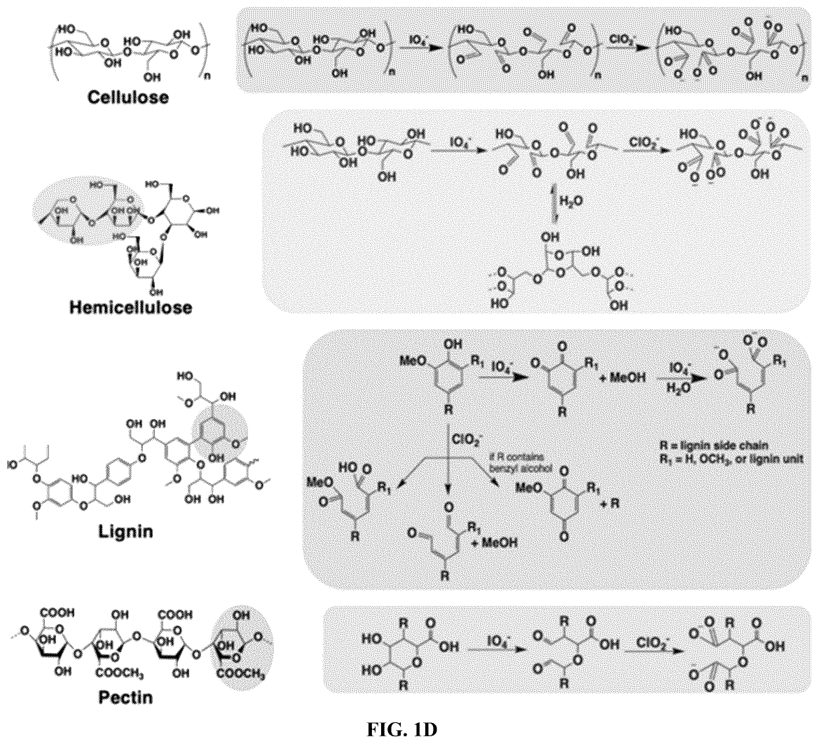

Referring to FIG. 1A, embodiments can relate to a method of forming a precipitate. The precipitate is formed via a sequential oxidation process applied to a biomass substance. The resultant precipitate can include fractions of biocolloids and microproducts bearing anionic groups in such concentrations (e.g., up to 6 mmol g⁻¹) to provide a high charge concentration. This high charge concentration can make the precipitate useful for many applications such as removal and recovery of elements (e.g., rear-earth elements) via adsorption, for example.

It should be noted that conventional methods of preparing charged biocolloids and microproducts require use of acid and are limited in providing no more than 1.75 mmol g⁻¹ of charge content (e.g., charge group per gram is at most 1.75 mmol g⁻¹). This typically involves strong acid hydrolysis and complete elimination of disordered regions of fibrils. The inventive method, however, is acid free and preserves disordered cellulose. While embodiments disclosed herein can be performed without the use of acids, strong or weak acids (e.g., HCl, H₂SO₄, H₃PO₃, etc.) or bases (e.g., NaOH) can be used along with the inventive method. It should be noted that acids or bases can be utilized before, during, and/or after any of the oxidation steps performed with the inventive method.

Embodiments of the method disclosed herein relate to chemical systems in which mixtures and solutions are formed, oxidation reactions and precipitation are promoted, agitation, quenching, etc. occurs. Chemical and physical parameters controlling these processes can be based on amounts, concentrations, kinetics, energetics, thermodynamics, etc. of the system and/or constituents of the system.

The method can involve oxidizing a biomass with sodium periodate (NaIO₄). This can be done to convert a hydroxyl group(s) of the biomass into an aldehyde group(s). The biomass can be a lignocellulosic material (e.g., softwood pulp, cotton, corncob, tomato peel, etc.). It is understood that the inventive method can be applied to other biomass substances, which can include polyphenolic compounds and carbohydrates (e.g., alginate, hyaluronic acid, chitin, chitosan, etc.). In addition, the inventive method can be applied to non-polysaccharide materials, such as lignin. Other sources can include fruits, hemps, plants, grass, etc. For the oxidation, the lignocellulosic can be paced in a solution subjecting it to NaIO₄. The solution can be stirred (e.g., mechanical, magnetic, ultrasonic, etc.) to promote agitation. This can be done for a predetermined amount of time. At the predetermined amount of time, ethylene glycol can be added to the solution to quench sodium periodate oxidation. For instance, ethylene glycol can quench any unreacted sodium periodate in the solution. The NaIO₄ oxidation can generate oxidative cleavage of vicinal diol at the C2-C3 bond of the biomass. The C2-C3 bond is the repeating unit of cellulous chains on cellobiose. Generating oxidative cleavage of vicinal diol can break the C2-C3 bond while oxidizing the hydroxyl group. More specifically, the oxidative cleavage of the vicinal diol at the C2-C3 bond on cellobiose breaks the bond while subsequently oxidizing the hydroxyl groups to convert them to aldehydes. This can form dialdehyde modified cellulose (DAMC).

The result of this first oxidation stage can be solid aldehyde-functionalized product. This lingocellulosic biomass biopolymer can them be isolated and remove from solution using a known filtering technique.

The method can involve a second oxidation stage. This can be oxidizing the sodium periodate-oxidized biomass (e.g., the solid aldehyde-functionalized product) with sodium chlorite (NaClO₂). This can be done to convert the aldehyde group(s) (e.g., dialdehyde moieties) into a carboxylate group(s). More specifically, the subsequent oxidation of DAMC with sodium chlorite selectively converts the aldehyde groups to carboxylate groups, which disintegrates the DAMC to nanocrystals as electrostatic repulsion among the crystals is increased. Although periodate oxidation is highly selective toward vicinal diols, reactions may also occur with phenolic guiacyl compounds, such as lignin, forming o-quinone structures.

For the oxidation, the solid aldehyde-functionalized product produced by the first oxidation stage can be dissolved in an aqueous solution of NaClO₂. In some embodiments, the method can involve subjecting the sodium periodate-oxidized biomass to a hypochlorous acid (HOCl) scavenger during the second oxidation stage. For instance, the HOCl scavenger can be added to the aqueous solution of NaClO₂ during the second stage oxidation. The HOCl scavenger can be hydrogen peroxide, for example. The scavenger is used to prevent HOCl from competing with the desired sodium chlorite oxidation.

The result of the second oxidation stage can be the formation of a micro- and/or nano-structured precipitate. This micro- and/or nano-structured precipitate can be isolated and removed from solution via centrifugation, for example. While centrifugation can be used for larger particles, isolation and removal of smaller particles may require exposing the solution to a poor solvent (EtOH). Thus, the isolation and removal can involve centrifugation and/or use of a poor solvent.

While embodiments disclosed herein describe use of external forces (mixing, centrifugation, fluidization, etc.) at one or more stages of the process, the inventive method can be performed without such external forces.

The resultant micro- and/or nano-structured precipitate can have a charge density equal to or greater than 0.01 mmol g⁻¹ but can be as high as 7.0 mmol g⁻¹. For instance, the precipitate can include anionic cellulose nanocrystals, which can comprise a crystalline body similar to that of conventional cellulose nanocrystals that are sandwiched between highly negatively charged disordered cellulose chains.

It should be noted that the resultant micro- and/or nano-structured precipitate can be anionic, cationic, zwitterionic, or electrically neutral.

As noted above, this high charge concentration can make the precipitate useful for many applications, which can include removal and recovery of elements (e.g., rear-earth elements) for example. For instance, electrostatic interactions between negatively charged carboxylate groups of the precipitate and positively charged elements (e.g., Nd³⁺) can facilitate adsorption of the elements by the precipitate. Thus, a substance containing the element of concern can be placed in a solution supporting the precipitate. This can cause adsorption of the element to the precipitate. Extraction of the elements can be achieved by protonating the carboxylate groups so as to neutralize their negative charge. Protonation can occur by lowering the pH of the solution. Upon lowering the pH, the carboxylate groups are protonated, which can cause release of the adsorbed element.

### EXAMPLES

The following describe exemplary highly charged micro- and nanomaterials and test results of making, using, and applying the same.

One of the main pillars of sustainable development is the preparation of functional materials derived from renewable resources. Lignocellulosic biomass, comprising highly abundant biopolymers such as cellulose, lignin, and hemicellulose, is an enormous source of renewable energy and feedstock chemicals, as well as a vast potential source for sustainable micro- and nanomaterials. Biomass-based nanomaterials have attracted great attention in recent decades due to their interesting properties and potential to replace petroleum-based polymeric materials. Nevertheless, facile methods to convert lignocellulosic biomass into value-added, highly functional micro- and nanomaterials remain limited. Here, we evaluate the potential of an acid-free method to universally convert a variety of lignocellulosic biomass into highly charged biocolloidal products. Sequential oxidation of both delignified (e.g., softwood pulp and cotton) and untreated (e.g., corncob and tomato peel) lignocellulosic sources yielded three distinct fractions of biocolloids and microproducts, bearing anionic groups with a concentration of up to 6 mmol g⁻¹, which is beyond the theoretical charge content of crystalline bio-based nanomaterials, such as cellulose nanocrystals, and is among the highest charge density ever reported. As a proof-of-concept for sustainable rare-earth element (REE) recovery, we show how these functional bio-based products may enable the recovery of neodymium from aqueous media. This work provides new opportunities for the conversion of a wide array of lignocellulosic biomass into highly functional biocolloids for advanced sustainable applications (e.g., element recovery, water and body fluid treatment, tissue engineering and regeneration, energy storage and conversion, carbon capture and storage, and so forth).

### Materials

Four lignocellulosic sources were used as the starting materials for the experiments. Northern bleached softwood kraft pulp (NBSK) was provided by Resolute Forest Products. Whatman (Cytiva) Grade 1 Qualitative Filter Paper as a source of cotton was purchased from VWR. Corncob was purchased from a local grocery store (Green Giant Extra Sweet Corn-on-the-Cob). Tomato peels were isolated from organic tomatoes (free of pesticides) purchased from a local grocery store. Sodium metaperiodate (NaIO₄, >99.0%), sodium chlorite (NaClO₂, 80%), sodium chloride (NaCl, >99.5%), hydrogen peroxide (H₂O₂, 30 wt %), sodium hydroxide (NaOH, ACS Reagent >97%), ethylene glycol (Reagent plus >99%), hydrochloric acid (HCl, ACS reagent, 37 wt %), hydroxylamine hydrochloride (NH₂OH·HCl, Reagent plus 99%), poly-L-lysine solution (PLL, 0.1% w/v in water), and neodymium (III) chloride hexahydrate (NdCl₃·6H₂O, 99.9% trace metal basis) were purchased from Sigma-Aldrich, USA. Anhydrous ethanol (EtOH, 200 proof) was supplied by KOPTEC, USA. Deionized (DI) water was used in all experiments unless otherwise specified. Milli-Q water from a Millipore Direct-Q 5 Remote Water Purification System was used when specified.

### Periodate-Chlorite Oxidation of Lignocellulosic Sources

For each of the four lignocellulosic sources, an oxidation procedure was used for the syntheses of hairy nanocelluloses. Softwood pulp and cotton filter paper were first cut into small, thin pieces with a size of approximately 2 cm×2 cm. Corncob was isolated by removing the corn kernels, drying, and grinding the cobs using a fruit blender. Tomato peel was isolated by first boiling the tomatoes and removing the peels, followed by drying and grinding using a fruit blender. Each starting material (1 g) was submerged in water and soaked via mechanical stirring overnight, disintegrated using a fruit blender, and vacuum filtered. NaIO₄ (1.32 g) and NaCl (3.8 g) were dissolved in water (65 mL total, including the volume of water absorbed by the starting material), and the wet starting material was added and allowed to react for 42 h while being mechanically stirred. The beaker was wrapped with two layers of aluminum foil to prevent light-induced NaIO₄ deactivation. Once complete, ethylene glycol (1 mL) was added to quench unreacted NaIO₄, and the mixture was stirred for an additional 10 min. The reaction mixture was then vacuum filtered and the solid aldehyde-functionalized product was rinsed 5 times with water to remove any residual reactant and byproducts. The aldehyde functionalized materials were then subjected to oxidation with NaClO₂ to convert aldehyde groups into carboxylate groups. First, NaClO₂ (0.8452 g) was dissolved in water (total volume=50 mL, including absorbed water by the solid), and the aldehyde-functionalized material was added to the mixture. Finally, H₂O₂ (0.8478 mL) was added dropwise, and the mixture was allowed to stir for 12 h. The pH was maintained mildly acidic, between 4.8 and 5.2, for at least the first 5 h or until the pH had stabilized by the addition of NaOH (0.5 M).

### Isolation of Carboxylated Products

Centrifugation and poor solvent precipitation were used to isolate three separate products of each lignocellulosic source: microproducts (MP), biopolymeric nanoparticles (BNP), and solubilized biopolymers (SB). The reaction mixture was first centrifuged at 15,000×g for 10 min to remove large MP. EtOH, a poor solvent, was added in 5 wt % increments to the supernatant to first precipitate BNP, followed by the SB. To separate the precipitates, centrifugation at 8,000×g for 10 min was used. All products were redispersed in water, and purified by dialysis (Spectra, M_{w} cutoff=6-8 kDa) against water for 24 h to remove any remaining salts and small molecules. All products were stored in 4° C. until further characterization.

### Functional Group Density Measurements

The concentration of aldehyde groups on the aldehyde-functionalized lignocellulosic sources following periodate oxidation was determined through titration with a strong base, using the NH₂OH·HCl method. A known amount (20 mg) of the aldehyde-functionalized materials was added to water (50 mL) and stirred magnetically. The mixture pH was decreased to 3.5 using HCl (0.1 M). Then, NH₂OH·HCl (10 mL, 5 wt %) was added and allowed to react with the aldehyde groups for 10 min, forming oxime groups, releasing HCl and lowering the pH. The mixture was then titrated with NaOH (10 mM, rate of 0.1 mL min⁻¹) using a Metrohm 907 Titrando automatic titrator until the initial pH (3.5) was reached. The aldehyde content was calculated based on the amount of HCl produced during the reaction of aldehydes with hydroxylamine using the volume of NaOH required to reach the initial pH. The concentration of carboxylate groups on all three carboxylated products, namely MP, BNP, and SB, was measured via conductometric titration. Each carboxylated product (20 mg) was combined with water (total water volume=140 mL, including the absorbed water in the redispersed samples) and NaCl (2 mL, 20 mM) under mechanical stirring, and the pH was set to 3 by adding HCl (0.1 M). Then, the mixture was titrated with a strong base (10 mM NaOH, addition rate of 0.1 mL min⁻¹) using a Metrohm 907 Titrando automatic titrator until there was excess strong base (pH ˜11). The carboxylate content was calculated based on the volume of strong base required to completely neutralize the weak acid (carboxylic acid, e.g., the middle region in the titration curves).

### Atomic Force Microscopy (AFM)

The morphology of BNP of all lignocellulosic sources was studied using AFM. The images were obtained using a Bruker Dimension Icon AFM with a silicon nitride probe (ScanAsyst-Air) under PeakForce tapping mode. The images were processed using the NanoScope Analysis (version 2.0). Samples were prepared by securing a freshly cleaved mica sheet onto a stainless-steel disc using Krazy Glue. A droplet of PLL (0.1% w/v) solution was placed on the negatively-charged mica surface and incubated for at least 15 min to impart a positive charge to the surface. The mica was then rinsed 5 times with 100 μL of Milli-Q water and allowed to dry for at least 30 min at the ambient condition. Once dry, the carboxylated BNP were added by placing one drop of the dispersion with a concentration of 0.1 mg mL⁻¹ on the PLL-coated mica sheet. The samples were allowed to dry overnight, rinsed 5 times with 100 μL of Milli-Q water, and allowed to dry at the ambient condition. Particle size analysis was conducted using Gwyddion software (version 2.49). The length and diameter of each BNP was measured by manually picking 50 particles and calculating the average and standard deviation.

### Optical Microscopy

MP of all lignocellulosic sources were imaged using a Nikon ECLIPSE TE300 Inverted Microscope at 4× and 10× magnifications. The images were analyzed using ToupTek ToupView software for Windows Version x64.

### X-Ray Diffraction (XRD)

The crystalline behavior of all lignocellulosic sources, MP, and BNP were assessed using XRD. The measurements were performed on a Malvern Panalytical Empyrean x-ray diffractometer with a PIXcel^{3D} detector with CuKα radiation (λ=1.54 Å). The x-ray diffractograms were acquired at 45 kV and 40 mA, with a 2θ (Bragg angle) range of 10-50°. Dry lignocellulosic samples were analyzed without any further preparation, and nanoparticle samples were dried to form a film and ground into a powder. The Segal crystallinity index (CI) of cellulose, shown in Equation 1, was used to estimate the crystallinity of the materials.

$$CI = \frac{( {I}_{200} - {I}_{A M} )}{{I}_{200}} \times 100 \qquad ( 1 )$$

In this equation, I₂₀₀ is the intensity of the (200) plane, typically located at a 2θ between 22 and 23°, and I_{AM} is the minimum of the diffractogram, which represents the disordered (amorphous) material, typically located at a 2θ between 18° and 19°. This method is widely-used, simple, and efficient for comparisons between many similar cellulose samples; however, it is generally not as accurate as the Rietveld method or full pattern fitting of the diffraction data, which may provide a better description of the crystallinity. In this work, the Segal method is considered adequate for drawing comparisons between lignocellulosic products.

### Fourier-Transform Infrared (FTIR) Spectroscopy

FTIR spectroscopy was used to characterize the functional groups of all lignocellulosic sources and BNP. Spectra were obtained on a Bruker Vertex 70 spectrometer (Bruker Optics Inc, Billerica, MA) in attenuated total reflection (ATR) geometry on a Diamax ATR accessory (Harrick scientific, Pleasantville, NY) with a diamond ATR crystal at a fixed incident angle of 45°. Samples were dried and ground using a mortar and pestle prior to measurement. Each sample was placed directly onto the crystal, and maximum pressure was applied by lowering the tip of pressure clamp via a ratchet clutch mechanism. A total of 500 scans were averaged at a resolution of 6 cm⁻¹ and the absorbance was calculated by referencing to a clean ATR crystal.

### Neodymium Removal and Recovery

A NdCl₃ stock solution (50 mM) was prepared by dissolving NdCl₃·6H₂O in water. Carboxylated MP from cotton filter paper were used as the adsorbent for all removal and recovery experiments and were dried completely prior to experiments. To study the effect of contact time on neodymium ion (Nd³⁺) removal, a fixed mass of adsorbent (3.5 mg, 500 ppm) was added to NdCl₃ solutions (initial Nd³⁺ concentration=145 ppm). The solutions were incubated for varying times (30 s, 1 min, 5 min, 10 min, and 1 h), excluding centrifugation time (˜5 min). The supernatant was separated from the adsorbent by centrifugation at 4,000×g for 5 min, and the Nd³⁺ equilibrium concentration in the supernatant, Cₑ, was measured using inductive couple plasma atomic emission spectroscopy (ICP-AES, Thermo iCAP 7400). The standard Nd³⁺ solution for calibration was prepared from a 1000 ppm stock solution, purchased from High Purity Standards (USA). The stock solution was carefully diluted to concentrations ranging from 0.05 ppm to 500 ppm. Quality control (QC) solution (EPA Method 200.7-6 Standard Solution A), purchased from High Purity Standard, was also used to ensure the measured concentrations were accurate. The maximum Nd³⁺ removal capacity of each adsorbent (qₑ) and the Nd³⁺ removal percentage were calculated using Equations 2 and 3, respectively, where C₀ (ppm) is the initial concentration of Nd³⁺, m (g) is the dry mass of the adsorbent, and V (L) is the total solution volume.

$${q}_{e} = \frac{( {c}_{0} - {c}_{e} )}{m} \times V \qquad ( 2 )$$

$$Removal ( \% ) = \frac{( {c}_{0} - {c}_{e} )}{{c}_{0}} \times 100 \qquad ( 3 )$$

To study the effect of time on Nd³⁺ recovery (desorption), HCl was added to the adsorbent following Nd³⁺ adsorption, adjusting the pH below the pKₐ of carboxylate groups (pKₐ₁=4.9, pKₐ2=7.9) to weaken the electrostatic interactions of carboxylate and Nd³⁺ as a result of carboxylate group protonation. Before adjusting the pH, the adsorbent was rinsed with water, stirred, centrifuged, and the supernatant was removed to liberate physically trapped Nd³⁺. Then, the solution pH was reduced to 1.2-1.3 using HCl, followed by incubation for the given times (30 s, 1 min, 5 min, 10 min, and 1 h), centrifugation at 4,000×g for 5 min, and Cₑ measurements using the ICP-AES. The recovery percentage was then calculated using Equation 4, where m_{recovered}(mg) was calculated using Cₑ following desorption, and m_{adsorbed}(mg) was calculated based on the removal capacity.

$$Recovery ( \% ) = \frac{{m}_{r e c o v e r e d}}{{m}_{a d s o r b e d}} \times 100 \qquad ( 4 )$$

### Statistical Analyses

Two-tailed 1-tests with assumed unequal variances were obtained for all results using Microsoft® Excel for Mac Version 16.54. All 1-tests were conducted using three repeats from the experimental results. Differences were considered significant when p≤0.05 was obtained. ns, *, **, and *** represent p>0.05, p≤0.05, p≤0.01, and p≤0.001, respectively.

### Results and Discussion

### Structure and Composition of Lignocellulosic Sources

FIG. 1B shows a schematic of periodate-chlorite oxidation of lignocellulosic sources. FIG. 1C shows four lignocellulosic sources and their approximate biopolymer composition. FIG. 1D shows chemical structure of lignocellulosic biopolymers and their oxidation reactions with periodate and chlorite. Four different lignocellulosic sources were used to study the universality of the periodate-chlorite oxidation for converting biomass to highly charged micro- and nanostructured materials. FIGS. 1B-1D summarize the compositions and reactions of the lignocellulosic sources. The two-step oxidation of cellulose to form three distinct products is schematically shown in FIG. 1B. When cellulose fibrils undergo the oxidation reactions, the products include AHCNC, dicarboxylated cellulose (DCC), and dicarboxylated cellulose microfibers. Lignocellulosic materials containing other polysaccharides yield anionic biopolymeric nanoparticles (BNP), solubilized biopolymers (SB), and microproducts (MP). To study the conversion of biomass to functional micro- and nanomaterials, the series of oxidations was applied to four sources: bleached softwood kraft pulp, Whatman™ grade 1 filter paper made from cotton linters, corncob, and tomato peel. The approximate content of lignocellulosic components—cellulose, hemicellulose, lignin, and/or pectin—for each source is shown in FIG. 1C. Softwood and cotton have both been treated during production to remove lignin and hemicellulose and therefore have a high cellulose content. The softwood used in these experiments comprises approximately 87% α-cellulose and 12% hemicelluloses. The cotton contains at least 98% α-cellulose. Both corncob and tomato peel were not pretreated and contain varying amounts of other lignocellulosic biopolymers, as well as pectin. According to literature, corncob comprises of 30-40% cellulose, 40% hemicelluloses, and 10-15% lignin, and tomato peels comprises about 20% cellulose, 50% hemicelluloses, 15-25% lignin, and about 10% insoluble pectin. Some fraction of pectin may be solubilized and thermally hydrolyzed during the initial processing of tomato peel. The varying compositions of these biopolymers in each lignocellulosic source may play a role in their oxidation and the properties of the resulting materials.

The structures and possible reaction pathways of each lignocellulosic biopolymer with periodate and chlorite are shown in FIG. 1D. Due to their similar structures, oxidation of cellulose, hemicelluloses, and pectin yield similar products. Periodate enables the oxidative cleavage of vicinal diols, e.g., on the C2-C3 of the cellulose anhydroglucose ring, breaking the bond while subsequently oxidizing the hydroxyl groups to aldehydes. Dialdehyde hemicelluloses may also form a cyclic 1,4-dioxane moiety in the presence of water. Due to the simple structure of pectin and its likeness to cellulose, subsequent periodate-chlorite oxidation likely does not yield any unexpected products other than the dialdehyde and dicarboxylate derivatives. Via chlorite-mediated oxidation, any dialdehyde moieties, such as that in cellulose, hemicelluloses, and pectin, are selectively converted into carboxylate groups. However, the complicated structure of lignin results in many possible reaction pathways. Although periodate oxidation is highly selective toward vicinal diols, reactions may also occur with phenolic guiacyl compounds, such as lignin, forming o-quinone structures. Further oxidation with periodate in the presence of water may also result in dicarboxylate groups and the cleavage of quinone ring. The phenolic unit of lignin may also react with chlorite to form a variety of products, including muconic acid ester, o-quinone, and p-quinone.

### Periodate Oxidation of Lignocellulosic Sources

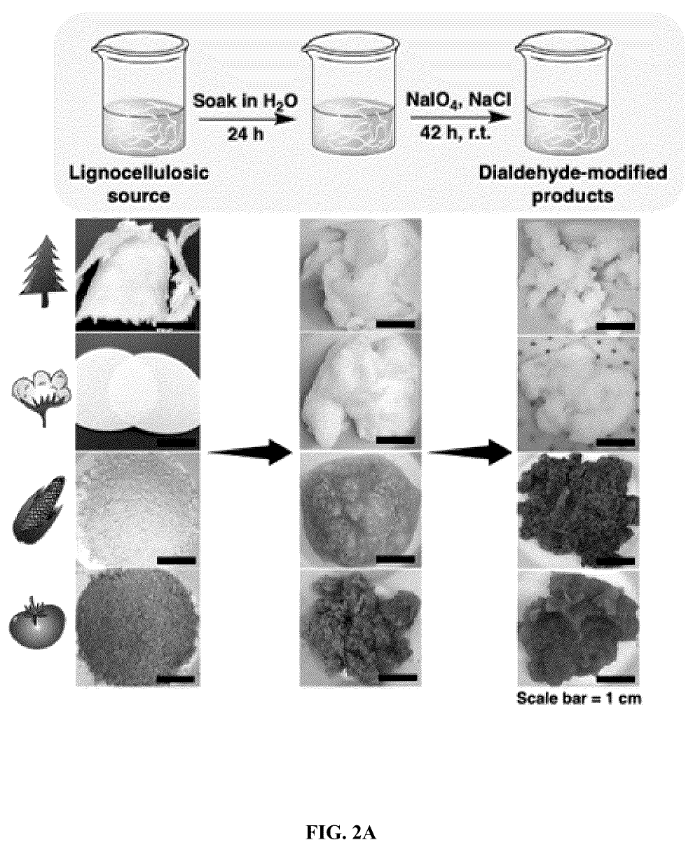

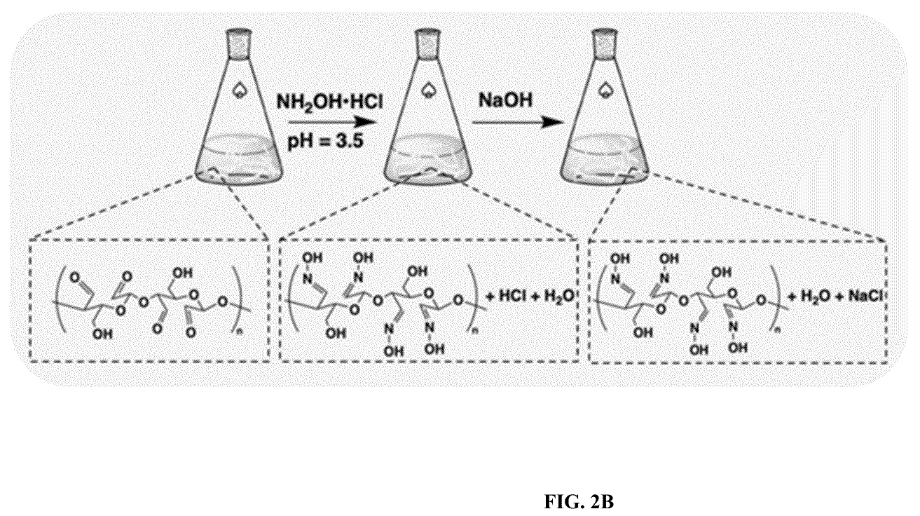

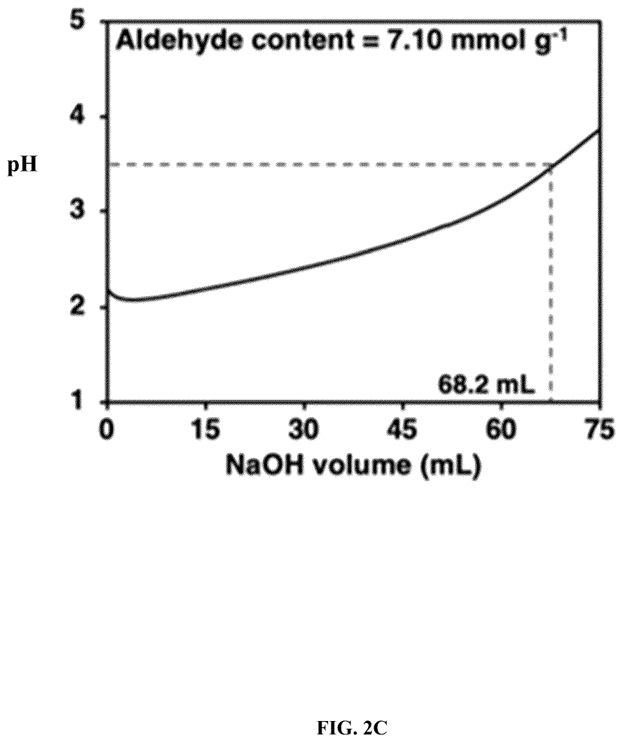

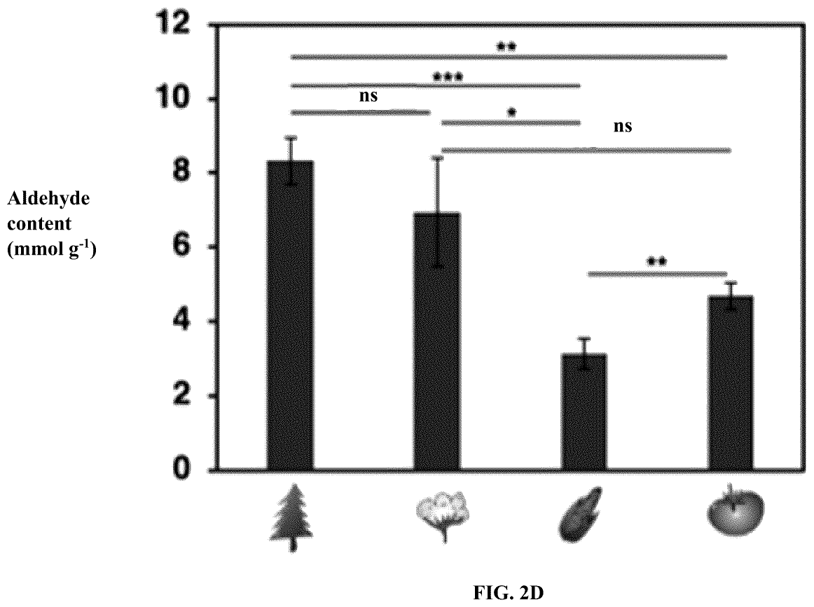

FIG. 2A shows a schematic of dialdehyde modification of lignocellulosic sources and images of each source without any treatment, after soaking in water, and after periodate oxidation (left to right). FIG. 2B shows a schematic of hydroxylamine hydrochloride titration to measure the aldehyde contents for each dialdehyde-modified lignocellulosic product. FIG. 2C shows a representative titration curve of dialdehyde-modified cellulose from the softwood kraft pulp. FIG. 2D shows aldehyde content of dialdehyde-modified lignocellulosic sources. All chemical syntheses were conducted in triplicate. Error bars indicate the standard deviation of three separate batches. ns, *, **, and *** represent p>0.05, p≤0.05, p≤0.01, and p≤0.001, respectively.

A schematic of the periodate oxidation procedure and the optical images of lignocellulosic sources in each step are shown in FIG. 2A. The initial materials are first soaked in water to form a biomass slurry, followed by dialdehyde modification, which does not result in solubilization at room temperature, thus the sources remain intact. While the integrity and color of softwood and cotton do not significantly change, a color change to a darker brown is evident in the dialdehyde-modified corncob, which has been previously observed in the periodate oxidation of materials containing high contents of lignin, indicating the formation of conjugated structures. The concentration of aldehyde groups on the oxidized products was determined using the NH₂OH·HCl titration method, shown schematically in FIG. 2B. As NH₂OH·HCl is added at a known pH (3.5), it reacts with the aldehyde groups, oximes are formed, and HCl is released. The volume of a strong base (NaOH) required to reach the initial pH after the reaction determines the concentration of oxime produced, and therefore, the aldehyde content of the material. The pH titration curve of DAMC from softwood is shown in FIG. 2C as a representative. The volume of NaOH required to reach the initial pH of 3.5 is 68.2 mL, corresponding to an aldehyde content of 7.10 mmol g⁻¹. In FIG. 2D, the aldehyde content of each lignocellulosic source following periodate oxidation is presented. Of the four sources, softwood has the highest aldehyde content, with an average of 8.33±0.63 mmol g⁻¹. Although cotton has the highest cellulose content, there is not a significant change in the aldehyde concentration (e.g., 6.95±1.40 mmol g⁻¹) compared with softwood. This may be due to the variation in hemicellulose content between softwood and cotton. It has been shown that hemicelluloses may play a significant role on the nanofibrillation of cellulose. During the mechanical disintegration of cellulose fibrils with varying hemicellulose contents, it has been shown that pulps with a higher hemicellulose content are more prone to nanofibrillation, enabling a higher yield of CNF production. This has been ascribed to the hemicellulose hydrogen bonding with cellulose fibrils, reducing the likelihood of fibrillar aggregation, which indicates that a higher content of hemicellulose may increase accessible fiber surfaces, and therefore, promote periodate reaction with cellulose chains. Hemicelluloses can also be functionalized with aldehydes through this oxidation, but are likely to be solubilized in this step and are removed in the filtration process because of their low molecular weight and readily-hydrolysable polymer chains.

The untreated sources, e.g., corncob and tomato peel, have a lower aldehyde content: 3.15±0.41 and 4.69±0.36 mmol g⁻¹, respectively. This is likely due to the presence of high amounts of lignin in the raw lignocellulosic materials. The role of lignin in the plant cell wall is to enhance its rigidity, increase hydrophobicity, and act as a barrier against pathogens and pests. It is often referred to as the “glue” of secondary plant cell wall, bearing phenolic groups to hold all other biopolymers in lignocellulosic biomass together. Several studies have shown that, in contrast to hemicelluloses, lignin may hinder the nanofibrillation of cellulose fibrils, and only residual amounts of lignin (e.g., 2-3%) may be beneficial to the formation of CNF than larger amounts. This result implies that the cellulose can be more easily accessed at a lower lignin content.

### Chlorite Oxidation of Dialdehyde-Modified Products

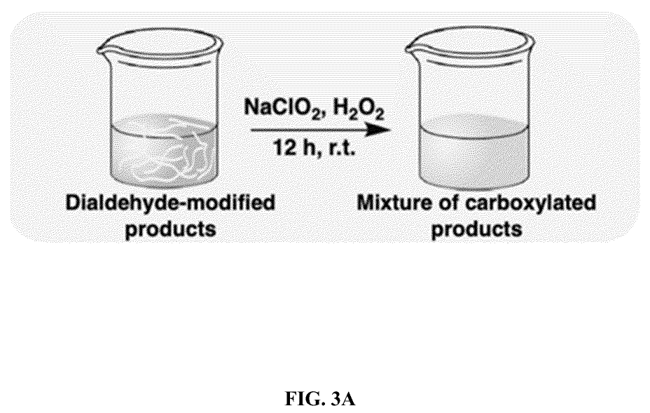

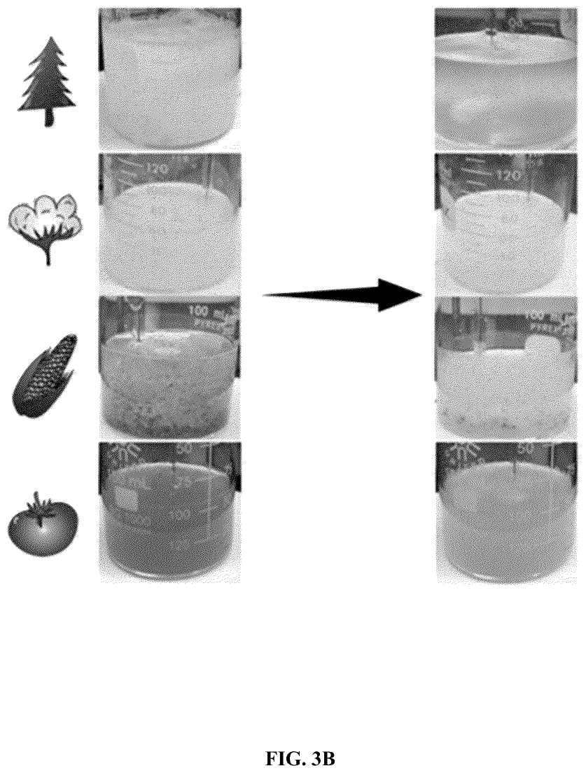

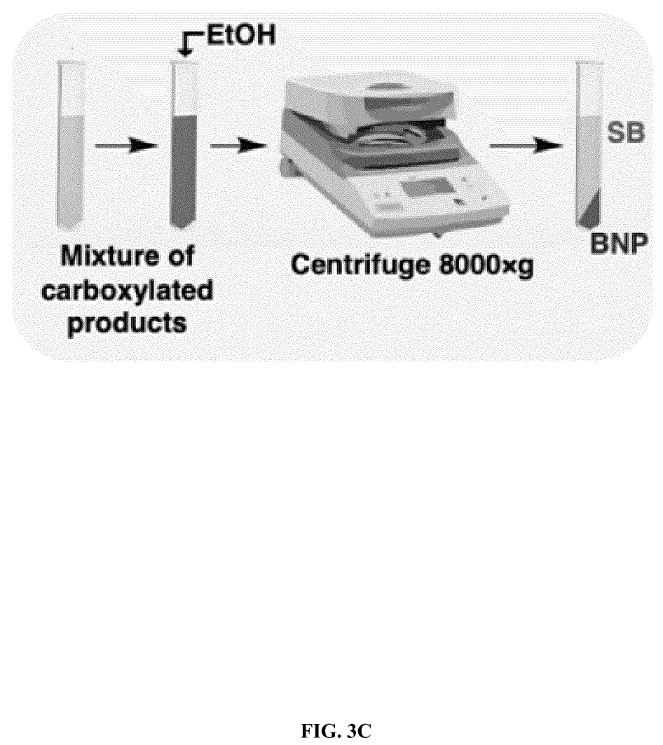

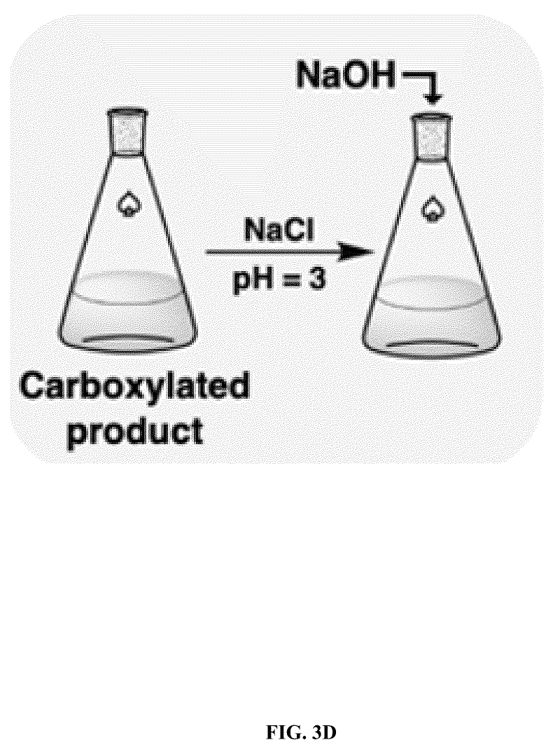

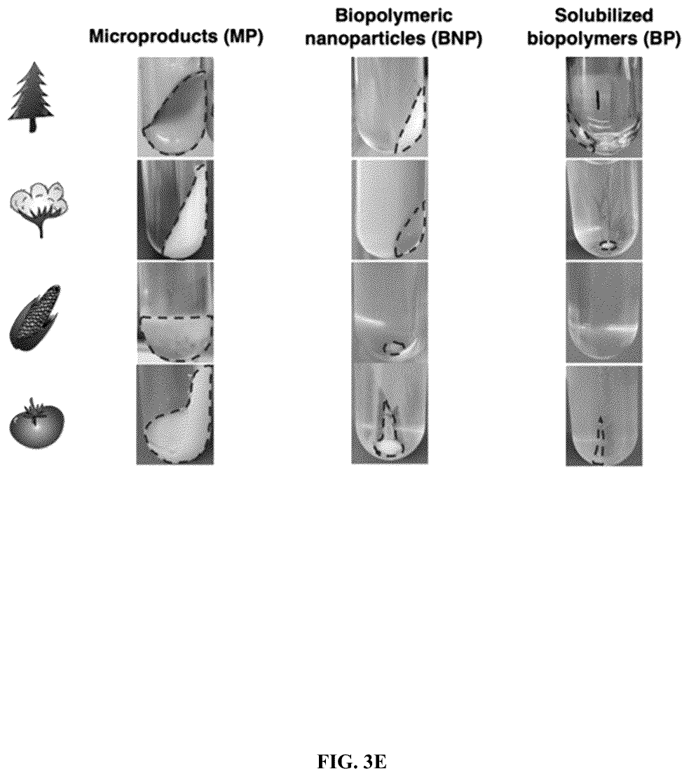

FIG. 3A shows a schematic of dicarboxylate modification of dialdehyde-modified lignocellulosic sources via chlorite oxidation. FIG. 3B shows optical images of lignocellulosic sources before and after oxidation with chlorite. FIG. 3C shows a schematic of poor solvent-mediated precipitation to separate the BNP from the SB. FIG. 3D shows a schematic of the conductometric titration for measuring the carboxylate group content of products. FIG. 3E shows images of the three products obtained from the periodate-chlorite oxidation of lignocellulosic sources, followed by precipitation. The precipitated products are outlined as a guide to the eye.

FIG. 3A schematically shows the procedure for the chlorite oxidation of dialdehyde-modified lignocellulosic sources. The chlorite oxidation selectively converts aldehyde groups into carboxylate groups. Hydrogen peroxide is added as a scavenger of hypochlorous acid (HOCI), which is formed as an unwanted byproduct capable of competitive oxidation. The reaction between H₂O₂ and HOCI releases HCl, and the reaction pH is maintained mildly acidic by the intermittent addition of a strong base (NaOH). FIG. 3B shows the reaction mixtures of each dialdehyde-modified source before and after chlorite oxidation. The disintegration of cellulose into carboxylated products can be more clearly seen in softwood than cotton due to the transparency of the product mixture. As the sources are oxidized and BNP and SB are formed, they are dispersed or solubilized, rendering the mixture more transparent. The oxidation of corncob and tomato peel results in the lightening of color due to the bleaching properties of NaClO₂. Chlorite has frequently been used to bleach both corncob and tomato peel to remove lignin residues.

Following chlorite oxidation, centrifugation and poor solvent-mediated precipitation enable the separation of carboxylated products, and conductometric titration is used to measure the concentration of carboxylate groups, as shown schematically in FIG. 3C and FIG. 3D, respectively. High speed centrifugation is sufficient to isolate the first product, MP, due to its large particle size. Then, BNP is isolated from SB by the addition of a poor solvent, such as EtOH. This is based on the theory of sterically-stabilized colloids, which states that colloids will flocculate when the Flory-Huggins polymer-solvent interaction parameter, χ, is equal to or larger than 0.5. Polymers will not phase-separate until the χ-parameter reaches higher values; therefore, the BNP can be separated first, and then the SB via further addition of EtOH.

Images of the three carboxylated products are shown in FIG. 3E. The chlorite oxidation of dialdehyde-modified lignocellulosic sources results in a mixture of three carboxylated products: MP, BNP, and SB. In cellulose, oxidation with chlorite introduces negative charges to the chains, which increases electrostatic repulsion and partially disintegrates the disordered regions, yielding AHCNC. The differences between the MP and BNP for softwood and cotton are notable. The transparency and opacity of the softwood and cotton MP, respectively, demonstrates that the softwood was more easily disintegrated through the oxidation processes. In agreement with this observation, softwood produced a higher fraction of BNP. When the source is more oxidized and disintegrated, the mass fraction of MP decreases, and the BNP increases. As expected, the corncob and tomato peel did not disintegrate to the same degree as the treated sources due to the presence of lignin, limiting the accessibility of biopolymers to the oxidants

### Mass Fraction and Charge Content of Carboxylated Products

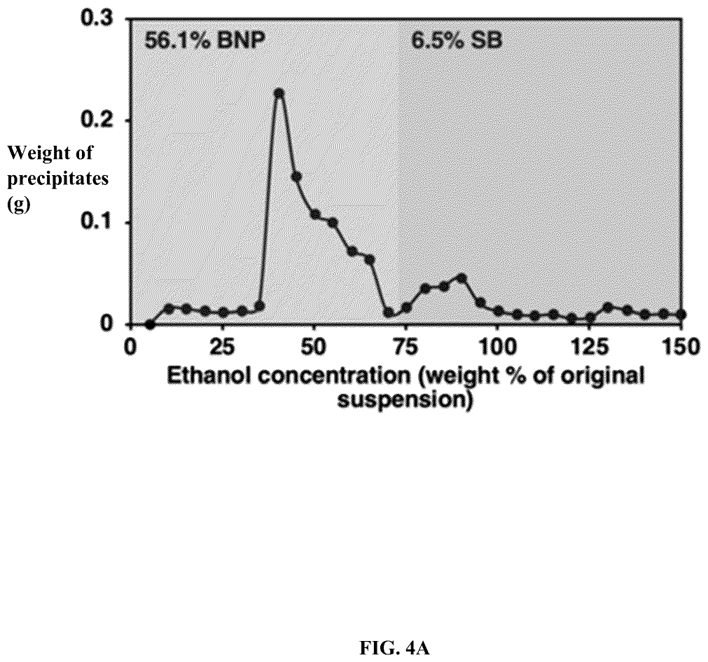

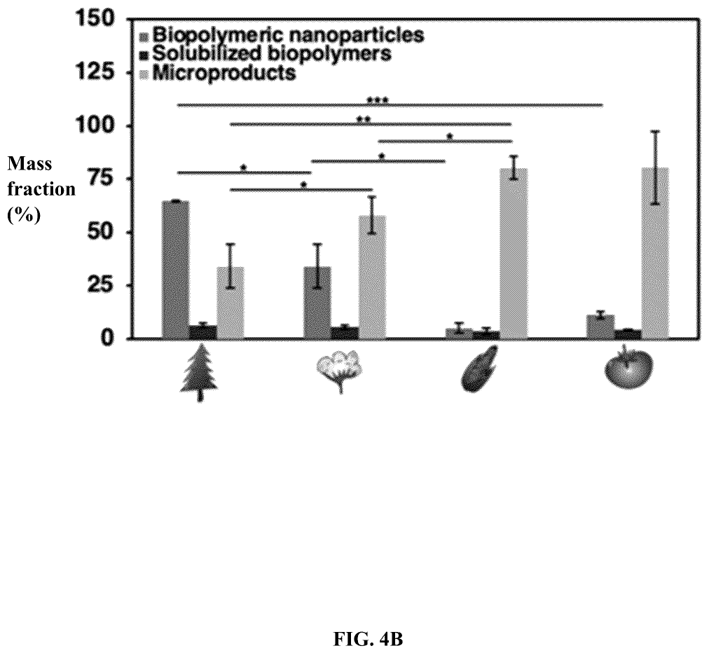

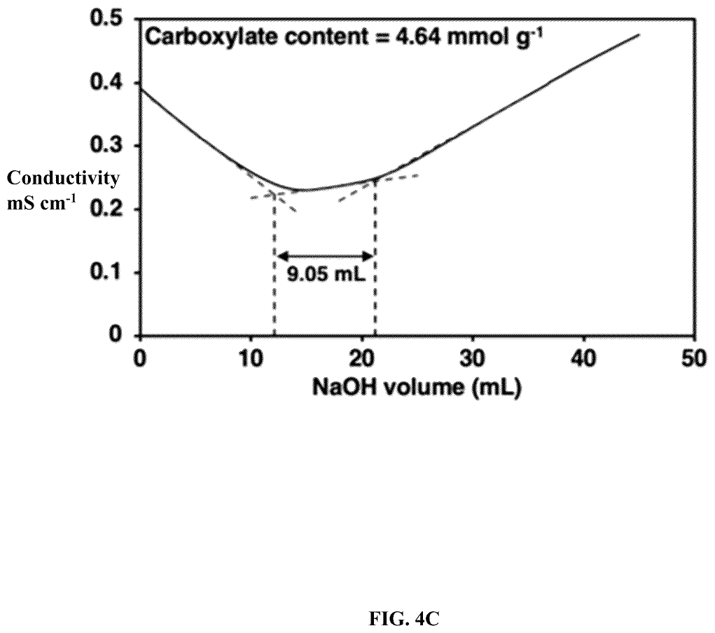

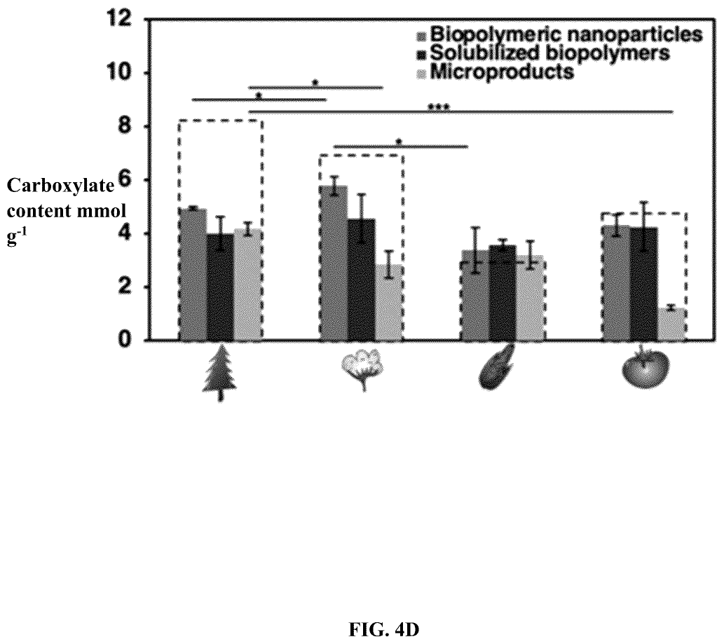

FIG. 4A shows representative data for the precipitated mass of softwood pulp BNP (AHCNC) and SB (DCC) versus poor solvent (EtOH) concentration. FIG. 4B shows production yield of MP, BNP, and SB based on the mass fraction for the lignocellulosic sources. FIG. 4C shows representative conductometric titration curve of softwood kraft pulp BNP (AHCNC). FIG. 4D shows carboxylate contents of the three products for four lignocellulosic sources. Dashed boxes represent the average aldehyde content of the dialdehyde-modified products prior to chlorite oxidation. In panels B and D, nonsignificant p-values are omitted for clarity. ns, * **, and *** representp >0.05, p<0.05, p<0.01, and p<0.001, respectively.

FIG. 4A shows a representative curve for the precipitation of softwood BNP and SB, demonstrating the poor solvent concentration-dependent isolation of the two products. By plotting the weight of precipitate versus the concentration of poor solvent, two distinct precipitated fractions are obtained. In the first fraction, a maximum weight is reached as the BNP precipitates out of the dispersion. The precipitate weight then reaches near zero, followed by an increase as the SB precipitates. The mass fraction of the three products for each source is shown in FIG. 4B. Softwood pulp has the highest yield of BNP, which is termed as AHCNC, with an average yield of 65.0±0.3%. A higher fraction of nanocrystals demonstrates that the softwood fibrils disintegrate more easily upon oxidation, and the average mass fraction of softwood MP is 34±10%. This relationship is seen in cotton as well. BNP only makes up 34 f 10% of the cotton products, while the MP is 58.0±8.5%.

There is a clear trade-off between yield of BNP and MP in both cases, demonstrating that the cotton cellulose fibrils are more difficult to disintegrate, as visually observed in FIG. 3E. Both softwood and cotton produce similar fractions of SB. Corncob and tomato peel produce mainly MP, with average fractions of 80.0±5.3% and 80±17%, respectively. This result agrees with the role of lignin in the lignocellulosic sources, hindering the separation of the lignocellulosic components from one another. In this case as well, the yield of solubilized polymers is low (≤6.5%), possibly as a result of the low accessibility of other biopolymers such as cellulose and hemicelluloses. This is in agreement with the optical images of the carboxylated products (FIG. 3E) and demonstrates how each source falls apart upon serial oxidation depending on the composition.

A representative conductometric titration curve for AHCNC and the carboxylate content of each product are shown in FIG. 4C and FIG. 4D, respectively. For treated sources (e.g., softwood and cotton), all carboxylate content values are smaller than the average aldehyde contents of the initial dialdehyde-modified materials (shown with dashed boxes in FIG. 4D). For the untreated sources (e.g., corncob and tomato peel), the carboxylate content may reach or even slightly exceed the initial aldehyde content due to the direct lignin reaction with chlorite without prior functionalization with aldehydes. The carboxylate content of cotton BNP (5.76±0.34 mmol g⁻¹) is higher than that of softwood (4.93±0.06 mmol g⁻¹). This may be related to the critical carboxylate concentration required to disintegrate the cellulose fibrils. To successfully solubilize disordered cellulose regions, a sufficient amount of charged groups need to be introduced. Previous results indicate that the cotton did not disintegrate as easily and resulted in a lower fraction of BNP (FIG. 3E), which agrees with the hypothesis that a higher charge content is required to solubilize the disordered regions of cotton cellulose. The carboxylate content of softwood is higher than cotton MP, further suggesting that the cotton MP does not bear enough charges to disintegrate. This may be because of the highly packed crystals in cotton cellulose, along with the absence of hemicelluloses, so a majority of the charge ends up on the disordered cellulose (e.g., BNP). Despite the low yield of both corncob and tomato peel BNP, they both have relatively high carboxylate contents of 3.37±0.86 and 4.30±0.40 mmol g⁻¹, respectively. Despite being lower than softwood and cotton, to the best of our knowledge, the charge content of these products is much higher than any reported nanomaterials synthesized from corncob or tomato peel. Tomato peel MP has a low carboxylate content, 1.21±0.09 mmol g⁻¹, compared with corncob, which has a carboxylate content of 3.18±0.52 mmol g⁻¹. This may be attributed to the higher content of lignin in tomato peel and also the presence of pectin, which acts as a host matrix for cellulose microfibrils in the primary plant cell wall, binding to the hydrophilic surfaces of cellulose. There are no significant differences between the SB carboxylate content of any sources. This suggests that there is some critical content of negative charge, above which accessible biopolymers will be solubilized in all of the lignocellulosic sources.

Crystallinity, kinetics, and functional group analyses of lignocellulosic sources and micro-/nano-products

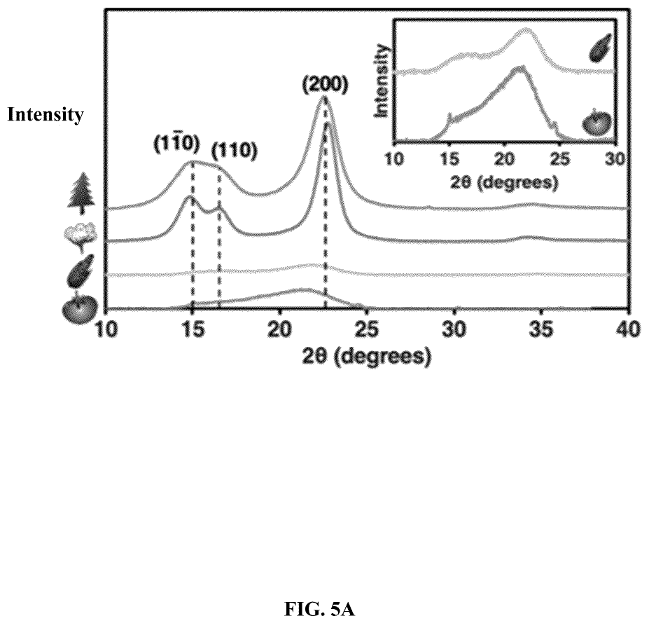

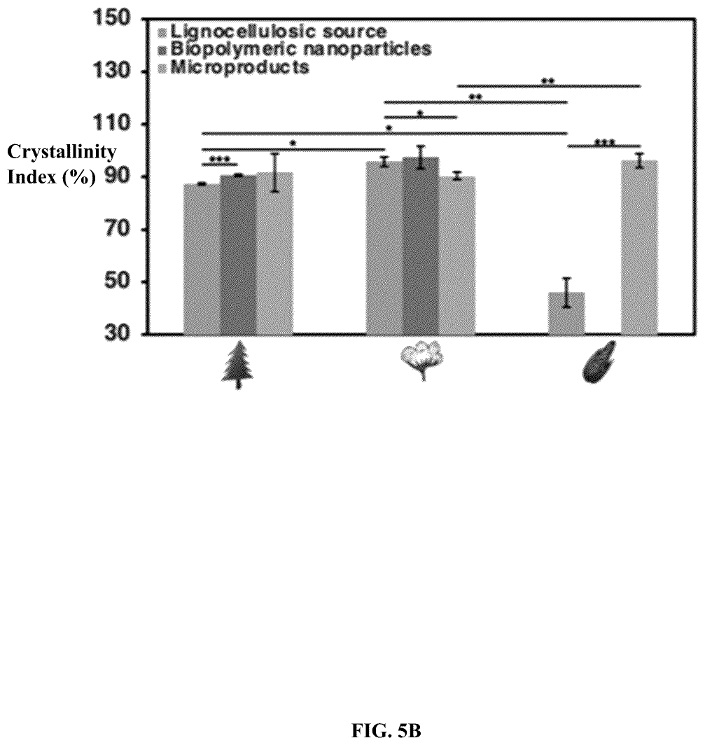

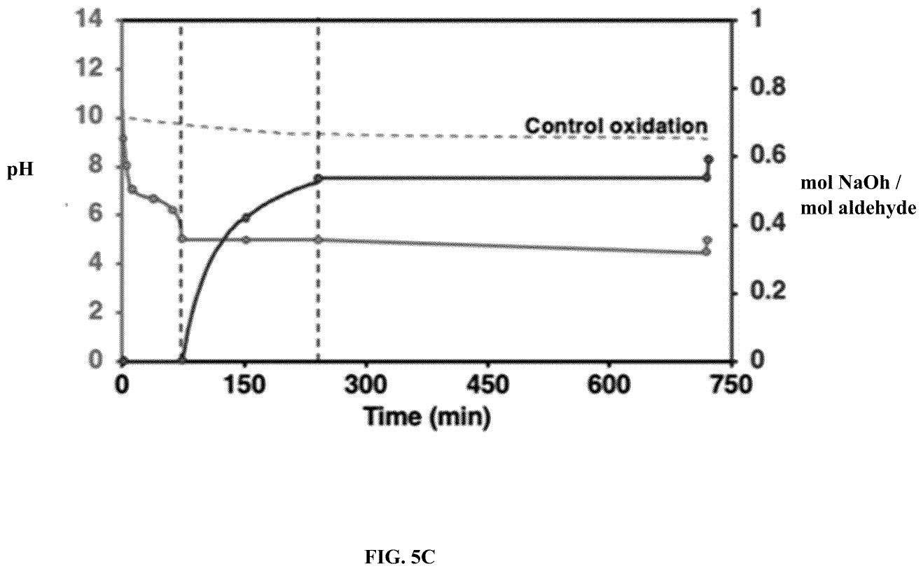

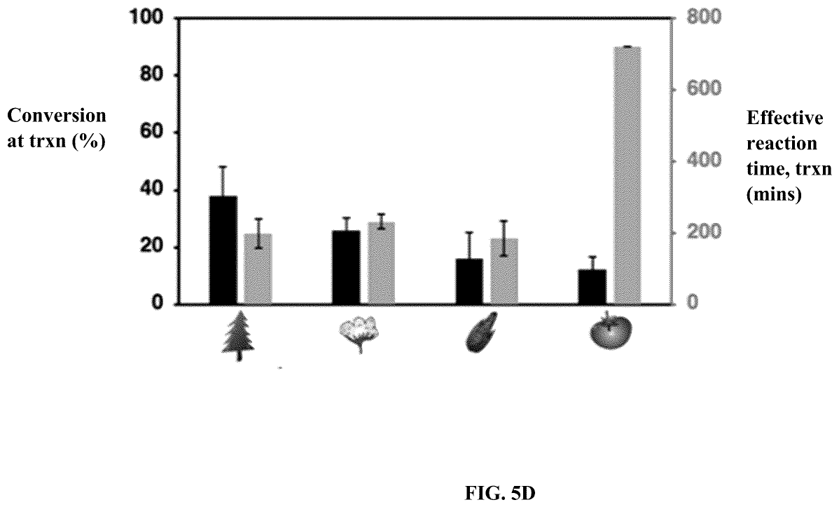

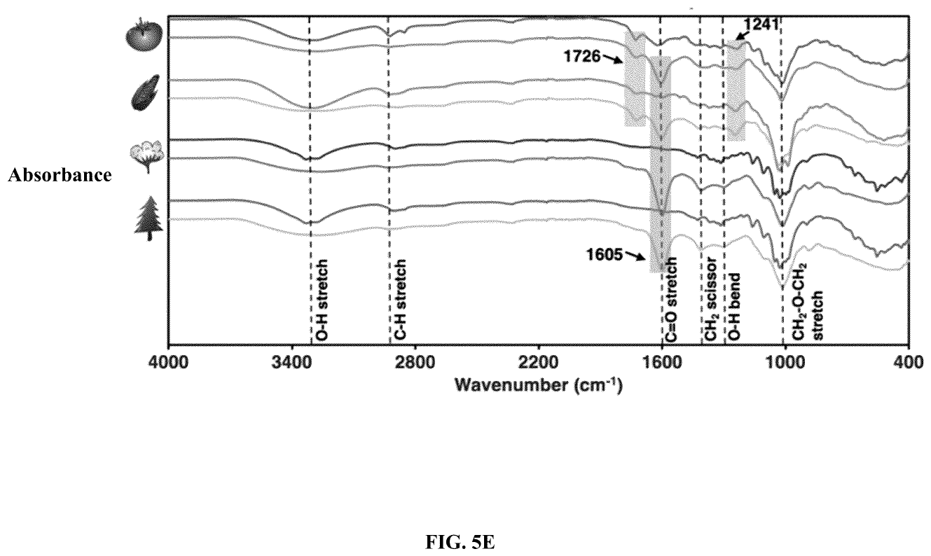

FIG. 5A shows XRD patterns of the lignocellulosic sources prior to any treatment. The inset is the zoomed-in pattern for corncob and tomato peel to magnify the important peaks. FIG. 5B shows the crystallinity index (CI) of initial lignocellulosic sources, MP, and BNP for each source. The CI of tomato peel and its products could not be calculated due to the overlapping peaks of amorphous materials such as lignin. Nonsignificant p-values are omitted for clarity. ns, *, **, and *** represent p>0.05, p<0.05, p<0.01, and p<0.001, respectively. FIG. 5C shows representative pH change and NaOH addition (mol/mol aldehyde) during the chlorite oxidation of softwood DAMC, demonstrating the reaction kinetics. The pH change over time is shown in blue, and the amount of NaOH added to maintain the weakly acidic condition (pH˜5) is presented in red. NaOH added was normalized with the initial aldehyde concentration of DAMC. The dashed curve represents the pH change of an identical reaction in the absence of any lignocellulosic material, e.g., the control experiment. FIG. 5D shows conversion of aldehyde groups to carboxylate groups for each lignocellulosic source during chlorite oxidation, and the effective reaction time (trxn), defined as the time required to stabilize pH at 5. FIG. 5E shows FTIR spectra of each source (darker colors) and their BNP products (lighter colors). Characteristic peaks are labeled with dashed lines, and other peaks of interest are highlighted.

To further investigate the differences between the lignocellulosic sources and their products, the crystallinity, reaction kinetics, and functional groups of each source and their products were characterized. FIG. 5A shows the x-ray diffractograms from the unoxidized lignocellulosic starting materials. Both softwood and cotton exhibit the characteristic peaks of cellulose Iβ, the most common polymorph of cellulose, corresponding to the (11̅0), (110), and (200) crystalline planes, which is consistent with pure cellulosic materials. The diffractogram for raw corncob exhibits these peaks as well, albeit at a lower intensity, presumably because of the presence of amorphous lignin and other non-cellulosic compounds, as reported in literature. Tomato peel shows a large, broad peak at 2θ=15°-25° because the peaks originating from crystalline cellulose and the high content of amorphous phenolic compounds in lignin may overlap. Similar diffractograms of raw tomato peels prior to any bleaching or delignification have been reported due to overlapping peaks of lignocellulosic components.

The crystallinity of the lignocellulosic sources, BNP, and MP was investigated using their respective CI, calculated based on the Segal analysis of cellulosic peaks in the x-ray diffractograms. Although this method is not as accurate as others, such as the peak deconvolution or Rietveld methods, at describing the crystallinity, it is expected that an adequate estimation may be obtained to compare the crystallinity of bio-based materials. FIG. 5B shows the CI of carboxylated products from softwood, cotton, and corncob. The softwood pulp CI was 87.4±0.5%. Softwood BNP CI=90.7±0.4%, which is higher than the untreated source, possibly as a result of disordered cellulose removal via the oxidation processes. Cotton exhibits a higher CI than softwood with an average CI of 95.8±1.9%, which is in agreement with previous literature comparing cotton with softwood cellulose. Cotton BNP also had a small increase in CI to 97.5±4.4%, demonstrating the removal of some disordered cellulose, albeit at a lower scale due to the high initial crystallinity. Cotton MP had a CI of 90.4±1.5%, demonstrating a slight decrease in crystallinity, which agrees with previous characterizations of this product during the synthesis of HCNC. Raw corncob had a lower CI, 46.1±5.4%, possibly because of the higher amorphous lignin content than the softwood and cotton sources. The CI of corncob BNP was not calculated due to their amorphous nature, exhibiting a broad peak between 15° and 25°, perhaps indicating a high content of lignin in this product. However, corncob MP undergoes a large increase in crystallinity (CI=96.3±2.6%), which indicates the removal of a large amount of lignin and disordered cellulose/hemicelluloses following the serial oxidation. Due to the absence of characteristic cellulose peaks, CI was not calculated for raw tomato peel or any of its products. This is likely because of a large content of other lignocellulosic components, causing broad overlapping peaks.

To study the formation of the three carboxylated products over time, the kinetics of the chlorite oxidation for each source was investigated based on the conversion of aldehyde groups to carboxylate groups, producing HCl. FIG. 5C shows the representative kinetics for the chlorite oxidation of softwood based on the pH change and moles of strong base (NaOH) added to maintain the pH at ˜5 over time. The first portion of the curves corresponds to the drop in pH as aldehyde groups are rapidly converted to carboxylate groups and HCl is formed. Once the pH reaches 5, NaOH is added intermittently to maintain the pH at 5 over the course of reaction. Finally, the pH stabilizes and experiences only a small decrease over the following hours. A control reaction, shown with the dashed curve, was conducted at identical conditions and reactant concentrations, but without the addition of any lignocellulosic material. This control experiment demonstrates that the major drop in pH (pH˜10 to pH˜7) at the start of the biomass reaction is due to a rapid conversion of aldehyde groups to carboxylates. It is evident that the reaction mainly takes place within the first few hours, and negligible conversion occurs in the final hours. This curve also displays the amount of NaOH added to maintain the pH, normalized with the aldehyde content of the starting material, which also plateaus after the first few hours of reaction. This effective reaction time, which is defined as the time required for the pH to stabilize, and the percent conversion of aldehydes to carboxylates at the effective reaction time are shown in FIG. 5D. Softwood has the highest effective conversion, 38±10%, which is in agreement with the higher yield of softwood BNP. A higher conversion of aldehyde groups to carboxylate groups corresponds to further disintegration of the lignocellulosic sources into nanoparticles as a higher density of negative charge is introduced. The average conversion of cotton is approximately 25.9±4.2%, which also agrees with previous results showing that the cotton cellulose fibrils do not disintegrate to BNP as efficiently as softwood (FIG. 3E and FIG. 4B). The average conversion of both corncob and tomato peel are lower compared with the treated sources, with values of 16.1±9.1% and 12.2±4.3%, respectively. Notably, the effective reaction time of tomato peel is much higher than the other sources, indicating that the conversion of aldehyde groups to carboxylate groups in tomato peel is slower and less efficient than the other sources. This may a result of higher lignin and pectin content in tomato peels.

FIG. 5E presents the FTIR spectra for all four lignocellulosic sources and their corresponding BNP products. Characteristic cellulosic peaks are seen in all materials. The broad peak at 3300 cm⁻¹ corresponds to O—H stretching in the abundant hydroxyl groups on cellulose, as well as lignin, hemicellulose, and pectin, while the peak at 2900 cm⁻¹ is observed in all the FTIR spectra of hydrocarbons, attesting to the C—H stretching. For both softwood and cotton sources, the peak assigned to O—H stretching contains another distinct peak at 3290 cm⁻¹, rendering the peak jagged. This may be ascribed to inter- and intramolecular hydrogen bonding in cellulose, which is stronger in the lignocellulosic sources with high cellulose content and diminishes as the highly charged BNP are formed. The peaks observed at 1410, 1300, and 1015 cm⁻¹ are correlated to CH₂ scissor bending, O—H bending, and CH₂—O—CH₂ stretching, respectively. The lignin in raw corncob, tomato peel, and their BNP products is confirmed based on the characteristic peaks at 1726 and 1241 cm⁻¹, representing C—O stretching in the side chain and guaiacyl ring of lignin, respectively. This confirms that corncob and tomato peel BNP contain lignin, which agrees with the broad nature of the diffractograms discussed previously (FIG. 5A). A peak at 1605 cm⁻¹ representing the COO⁻ stretching vibration is seen in all four BNP demonstrating the formation of carboxylate groups via chlorite oxidation. Raw tomato peel also has a peak at around 1600 cm⁻¹, which may be a result of the aromatic skeleton vibrations that are common for lignin.

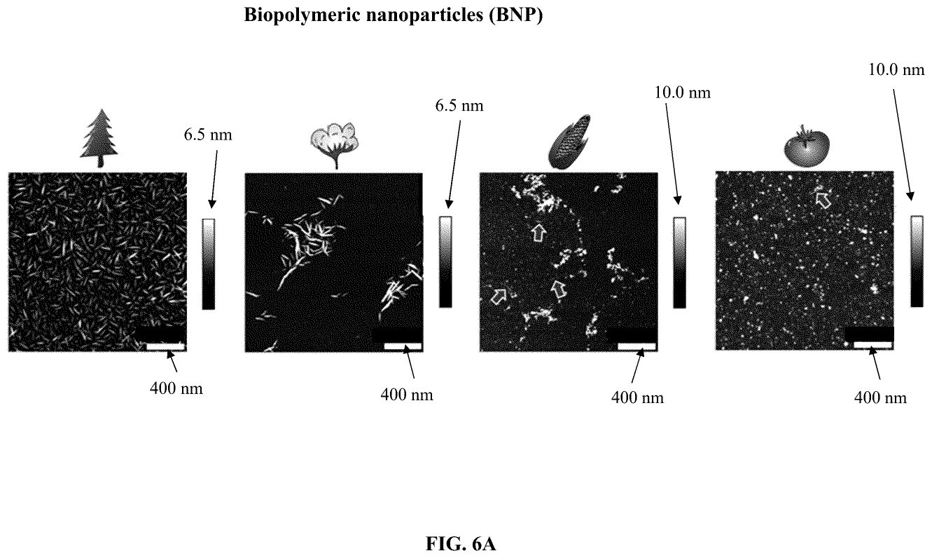

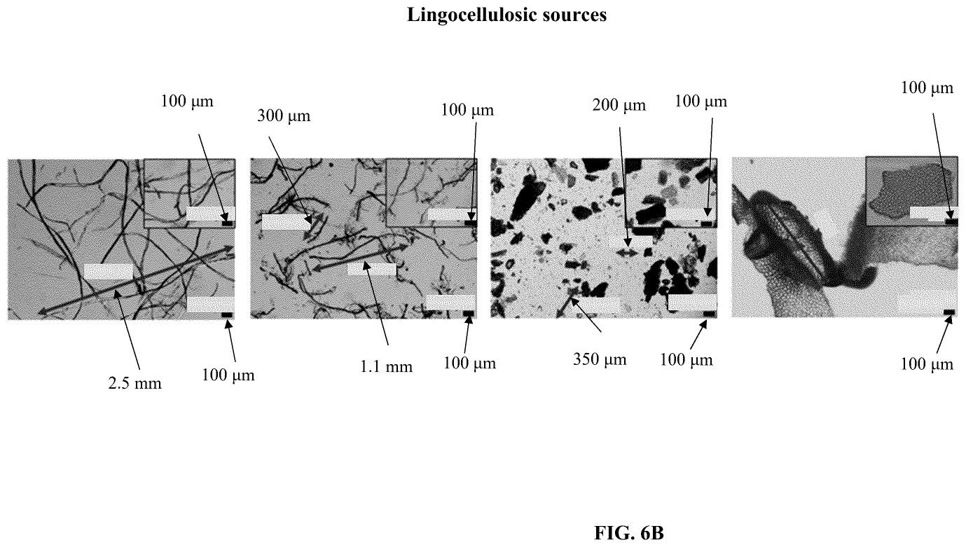

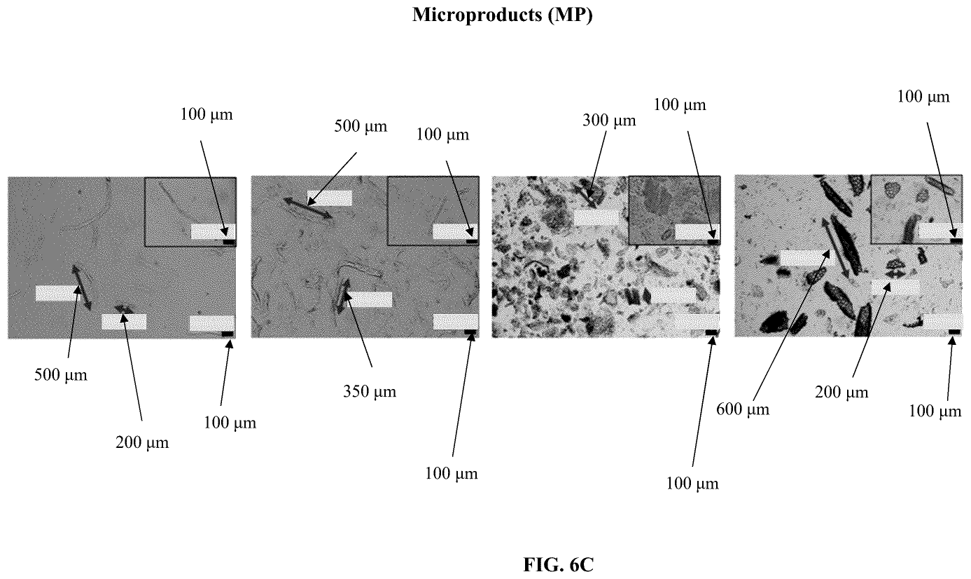

FIG. 6A shows AFM images of BNP synthesized from the lignocellulosic sources. While the BNP of softwood pulp and cotton were all needle-shaped, only a few needle-like nanoparticles were obtained from the corncob and tomato (arrows). FIG. 6B shows optical microscopy images of lignocellulosic sources prior to oxidation. FIG. 6C shows optical microscopy images of MP following the chlorite oxidation of dialdehyde-modified lignocellulosic sources. All optical microscopy images were taken at 4× magnification, and the insets were taken at 10×. Representative lengths are shown with arrows.

The AFM images of BNP obtained from each source are shown in FIG. 6A. Cellulosic nanocrystals are seen for both softwood and cotton, attesting to the characteristic needle-like crystalline regions of cellulose fibrils. The softwood nanocrystals are noticeably smaller than those of cotton. The length and width of the softwood BNP are 87.5±29.3 nm and 10.1±3.1 nm, respectively, and the cotton BNP have dimensions of 91.7±30.6 nm by 11.8±2.6 nm. The size difference between them is because of the higher crystallinity of cotton cellulose, which may correspond to longer crystalline regions. The BNP of both corncob and tomato peel, with diameters of 11.0±2.9 nm and 10.4±3.0 nm, respectively, do not resemble CNC because of the other components of raw lignocellulosic materials, namely lignin. The pseudo-spherical nanoparticles seen in the images resemble those previously reported for lignin nanoparticles (LNP). Although, those reported in this work bear a much higher content of negative charges. As an example, LNP synthesized via ultrasonication had approximately 1 mmol g⁻¹ carboxylate groups. Arrows are used to highlight small amounts of needle-like nanocellulose particles, suggesting that some cellulose nanocrystals are produced, though the majority of product is the LNP.

### Morphology of Lignocellulosic Sources and Nano-/Micro-Products

FIG. 6B and FIG. 6C present the optical microscopy of raw lignocellulosic sources prior to any oxidation and their corresponding MP following periodate-chlorite oxidation reactions, respectively. The unoxidized softwood fibrils are in the order of mm long and appear thick. Following the serial oxidation, they become shorter (e.g., 200-500 μm), swell and appear to be more transparent. Unoxidized cotton fibrils are shorter than those of softwood, attaining a length between 300 μm to >1 mm, and also appear more “frayed”. Similar to softwood, the oxidized cotton microfibrils are more swollen and shorter than those prior to oxidation. The corncob is not composed of noticeable microfibrils, but rather has a wide range of particle sizes and shapes. This irregular shape and size are also reported after the alkali and bleach treatment of raw corncob. However, the effect of oxidation is still apparent, as the microproducts are thinner (more transparent) and smaller, indicating some disintegration. Raw tomato peel has sizes on the order of millimeters, and the tomato epidermal cell wall is visible. Following oxidation, the tomato peel was converted to smaller particles (e.g., 200-600 μm long), and a majority of the products had a long aspect ratio, perhaps indicating directional disintegration.

### Neodymium Removal and Recovery

The biomass-based micro- and nanomaterials synthesized via sequential periodate-chlorite oxidation bear a high carboxylate group content. To demonstrate the proof-of-concept for element recovery using these sustainable materials, cotton MP was used as a model system for the removal and recovery of Nd³⁺, one of the five most critical rare earth elements (REE, a group of 17 metallic elements which are becoming increasingly important due to their role in many advanced applications, including permanent magnets, catalysts, electric cars, wind turbines, and fluorescent lamps). Neodymium is processed mainly in China, and the methods utilized to process it often uses large amounts of harsh chemicals, bringing forth environmental concerns. Due to the limited availability of Nd³⁺ and challenges with its processing, many researchers have looked to recycling neodymium from secondary sources, such as electronic waste (e-waste). There are several methods to accomplish this, however adsorption has emerged as a facile, low-cost method to enable the rapid and high capacity removal of Nd³⁺.

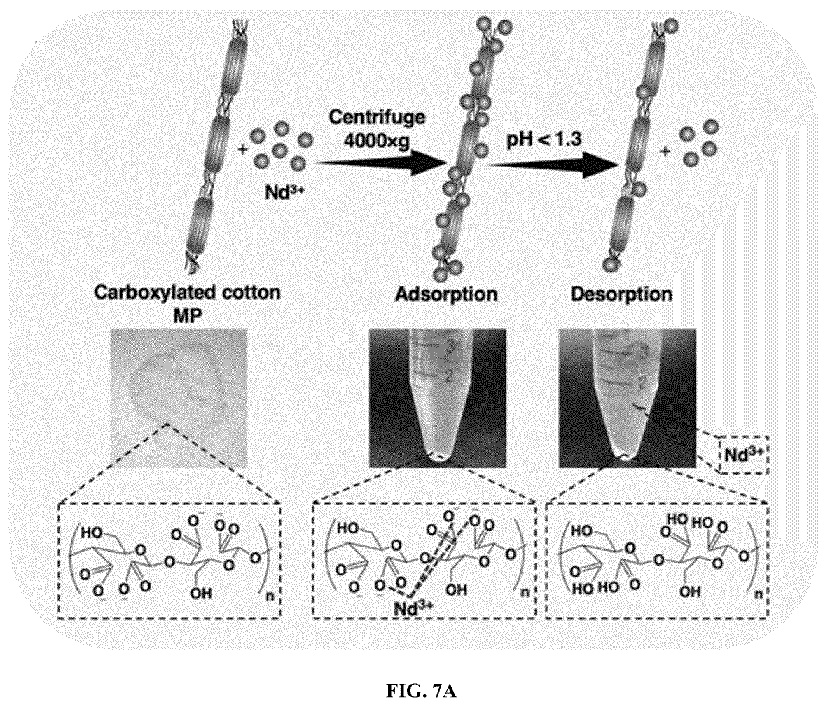

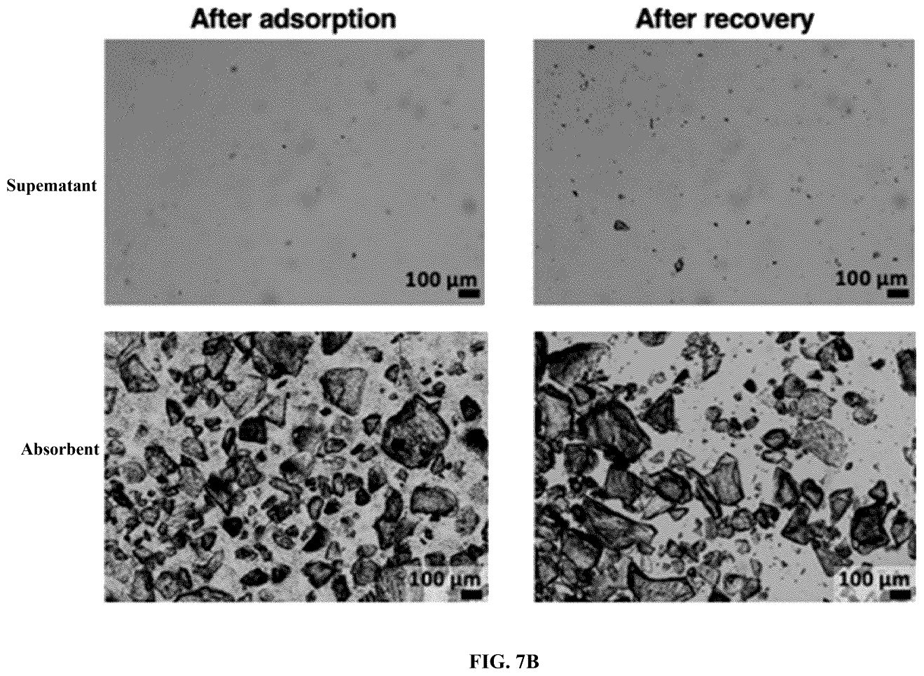

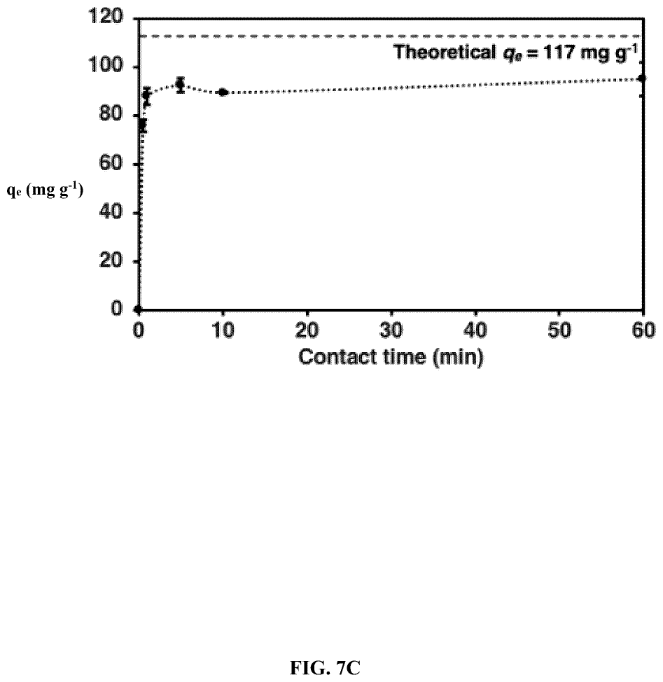

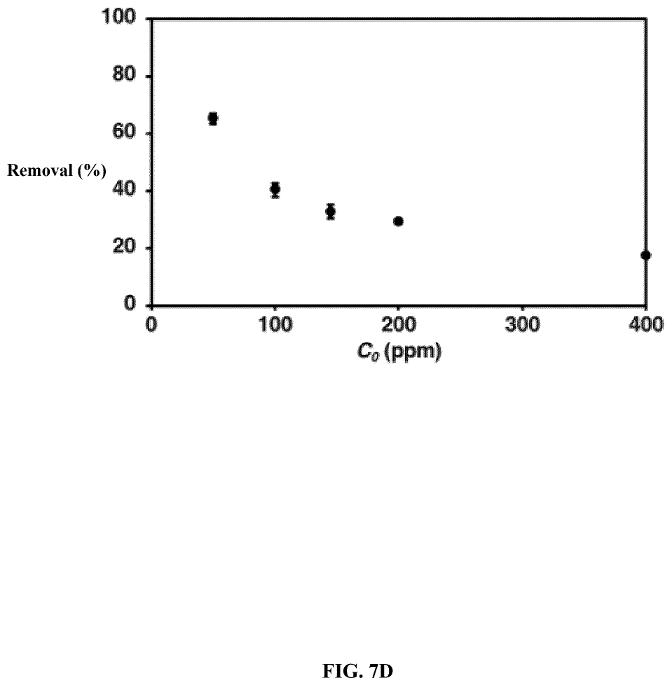

FIG. 7A shows a schematic of neodymium ion (Nd³⁺) removal and recovery using carboxylated cotton MP produced via the periodate and chlorite oxidation of cotton filter paper. Optical images and chemical structures of the adsorbent before adsorption, after adsorption, and after desorption. FIG. 7B shows optical microscopy images of supernatant and adsorbent after Nd³⁺ adsorption or recovery. FIG. 7C shows Nd³⁺ removal capacity of carboxylated cotton MP versus contact time. The theoretical Nd³⁺ removal capacity calculated based on the charge stoichiometry is shown with a dashed line. FIG. 7D shows Nd³⁺ removal percent versus the initial Nd³⁺ concentration (C0). FIG. 7E shows recovery of Nd³⁺ from cotton MP after absorption via rinsing with water, followed by lowering the pH.

The carboxylate content of the adsorbent, dried carboxylated cotton MP, is ˜2.44 mmol g⁻¹. This is lower than that of AHCNC, the BNP formed from softwood, which we recently used to effectively remove high concentrations of Nd³⁺ from the aqueous media. However, the microscale particles of MP enable the facile separation of adsorbent and element recovery as opposed to dispersed nanoscale particles of AHCNC. FIG. 7A schematically shows the Nd³⁺ adsorption and desorption process using the carboxylated cotton MP. The electrostatic interactions between the negatively charged carboxylate groups and positively charged Nd³⁺ facilitate adsorption, and upon lowering the pH, the carboxylate groups are protonated, releasing Nd³⁺. FIG. 7B shows optical microscopy images of the supernatant and adsorbent after Nd³⁺ adsorption or desorption (recovery).

FIG. 7C presents the Nd³⁺ adsorption capacity of cotton MP adsorbent versus contact time. According to the carboxylate content of MP adsorbent and the stoichiometric ratio of COO⁻:Nd³⁺=3 mol:1 mol, complete carboxylate neutralization should take place at a Nd³⁺ concentration of ˜58 ppm. In these experiments, excess Nd³⁺ was used (145 ppm). As the contact time increases, the removal capacity increases. After about 5 min of contact time, the removal capacity of Nd³⁺ reaches ˜92.5±2.8 mg g⁻¹, which increases to 95.0±6.9 mg g⁻¹ at a contact time of 1 h. This is slightly lower than the theoretical maximum removal capacity of 117 mg g⁻¹, which may be because of incomplete separation of the adsorbent during centrifugation. As can be seen in FIG. 7B, smaller particles may remain in the supernatant (˜7%, on the order of 5-10 μm).

The removal percentage of Nd³⁺ at varying initial concentrations from 50 to 400 ppm is shown in FIG. 7D. At Cₒ=50 ppm, the removal is 65.2±1.9%, and by increasing C₀, the removal percentage decreases. With an initial Nd³⁺ concentration of 145 ppm, the removal is approximately 32.8±2.4%. This is expected with the excess amount of Nd ions above the removal capacity of adsorbent. The removal decreases further to 17.4±0.4% as Cₒ is increased to 400 ppm, showing that the excess Nd ions can no longer be adsorbed above charge stoichiometry and need more adsorbent. A maximum removal of approximately 65% at 50 ppm, below charge stoichiometry, agrees with the removal capacity. The adsorbent not reaching 100% of removal even below 58 ppm may also be due to the small adsorbent particles remaining in the supernatant.

To assess the recovery of Nd³⁺ after adsorption, the pH was decreased. To assure that both carboxylate groups on each anhydroglucose ring are protonated, thus displacing any adsorbed Nd ions, the pH was adjusted to below a value of 1.3. At this pH, theoretically, more than 99.9% of the carboxylate groups on the adsorbent are protonated. Prior to pH adjustment, the cotton MP were rinsed with water to remove any remaining unadsorbed (e.g., physically trapped) Nd³⁺. The recovery of Nd³⁺ was quantified with a ratio of the recovered mass, which is Nd³⁺ in the supernatant following pH adjustment, and the adsorbed mass, which is Nd³⁺ adsorbed upon initial contact with the adsorbent. After the MP was rinsed with water only, the recovery of Nd³⁺ was 8.9±1.4%, as shown in FIG. 7E. This implies that a small amount of Nd³⁺ remained on but not adsorbed to the cotton MP following adsorption, which is readily recovered just with the water rinse. Following pH adjustment to ˜1.2-1.3, the concentration of Nd³⁺ in the supernatant was measured again via ICP-AES, and a maximum of 55.4±2.1% recovery after 5 min was obtained. The significant increase in recovery following the pH adjustment imply that the Nd ions are successfully, but partially displaced as the carboxylate groups are protonated. With this protocol, a total of approximately 64% of the originally adsorbed Nd³⁺ is recovered. The remaining Nd³⁺ may be strongly trapped and may require lower pH to be liberated. These results demonstrate that the periodate-chlorite oxidation of lignocellulosic biomass yield highly functional sustainable micro-/nanoscale materials able to remove and recover elements, such as Nd³⁺.

Table 1 compares the charge contents of various lignocellulosic micro- and nanomaterials, most notably cellulose and lignin nanoparticles, demonstrating that the lignocellulosic biocolloids reported in this work bear a much higher charge density. Our facile, acid-free periodate and chlorite oxidation treatments followed by poor solvent-mediated precipitation enable the formation of both CNC and LNP from a wide range of lignocellulosic sources with the highest charge density reported thus far, to the best of our knowledge, as well as many other functional bio-products, such as MP and SB.

TABLE 1
Comparison of charge contents for various
lignocellulosic micro- and nanomaterials.

| | | Charge content | |
|---|---|---|---|
| Material | Preparation method | (mmol g⁻¹) | Ref. |
| AHCNC | Periodate-chlorite oxidation of cotton | 5.76 | This work |
| | linters | | |
| AHCNC | Periodate-chlorite oxidation of | 4.93 | This work |
| | bleached softwood kraft pulp | | |
| LNP | Periodate-chlorite oxidation of | 4.30 | This work |
| | untreated tomato peel | | |
| LNP | Periodate-chlorite oxidation of | 3.37 | This work |
| | untreated corncob | | |
| LNP | Acid precipitation of | 1.75 | [14] |
| | carboxymethylated lignin | | |
| CNC | Ultrasonic-assisted TEMPO oxidation | 1.66 | [71] |
| | of cotton linter pulp | | |
| Lignin-containing | Cationization of untreated sawdust with | 1.50 | [72] |
| cationic wood | carbamides and a cationization agent | | |
| nanofibers | | | |
| LNP | Sonication of aqueous dispersion of | 1.17 | [15] |
| | Sarkanda grass lignin | | |
| LNP | Aqueous dialysis of softwood kraft | 0.41 | [16] |
| | lignin dissolved in tetrahydrofuran | | |
| CNC | Alkali hydrolysis of sulfated cotton | 0.31 | [73] |
| | cellulose nanocrystals | | |
| Oxidized | Periodate oxidation and borohydride | 0.25 | [40] |
| lignocellulosic | reduction of chemothermomechanical | | |
| microfibers | pulp | | |
| Lignin-containing | Maleic acid hydrolysis of unbleached | 0.24 | [50] |
| CNC | hardwood chemical pulp | | |
| CNC | Sulfuric acid hydrolysis of bleached | 0.15 | [57] |
| | and delignified tomato peel | | |
| CNC | Sulfuric acid hydrolysis of cellulose | 0.07 | [74] |
| Lignin-containing | Mechanical fibrillation of partially | 0.02 | [50] |
| CNF | oxidized unbleached hardwood | | |
| | chemical pulp | | |

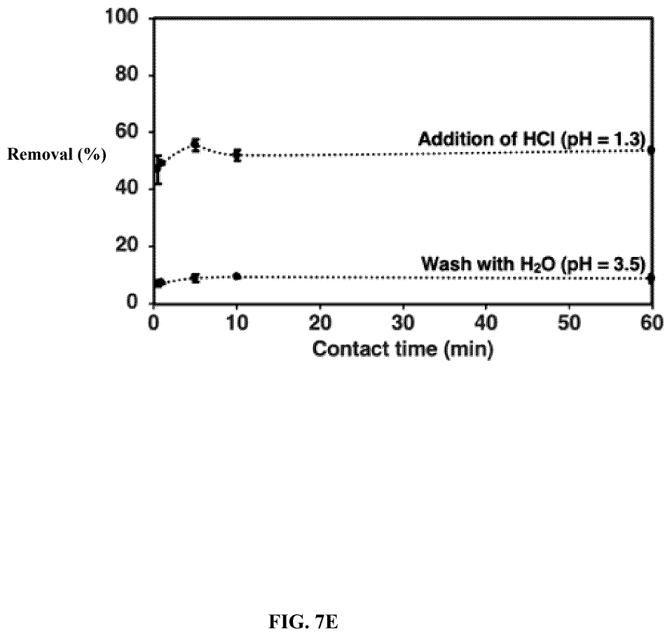

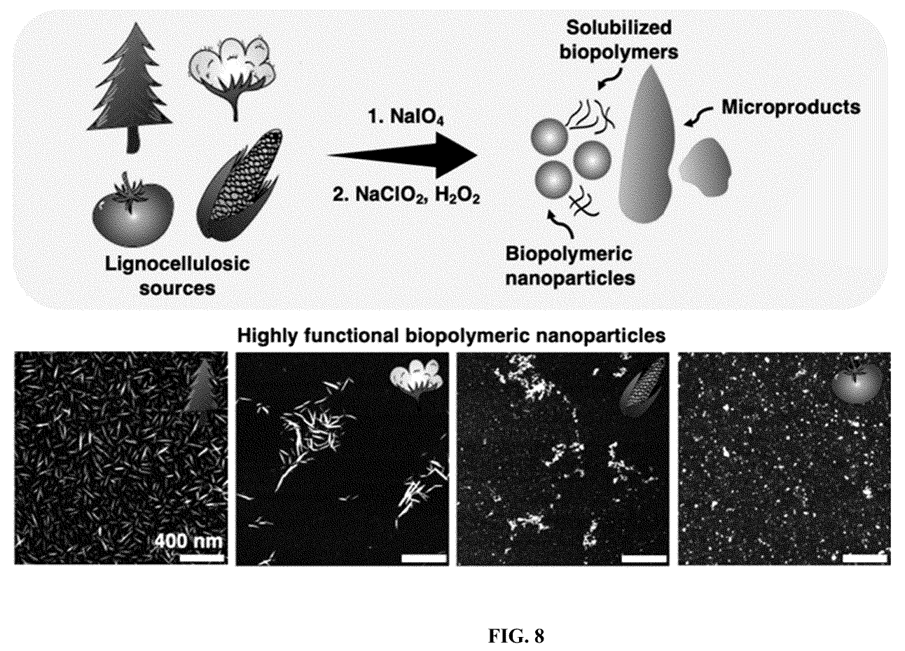

Referring to FIG. 8, embodiments of the method involved applying a two-step, acid-free oxidation procedure to a wide variety of lignocellulosic sources, including softwood, cotton, corncob, and tomato peel, to yield carboxylated biopolymeric nanoparticles (BNP), solubilized biopolymers (SP), and microproducts (MP) with a high degree of carboxylate substitution. Differences in polysaccharide composition and properties of the four pre-treated and untreated lignocellulosic sources led to noticeable differences in the functionalization and morphology of the three distinct products. Cellulose content and crystallinity had a key effect on the charge density, yield, and size of cellulose nanoparticles in the case of cotton and softwood sources. Other polysaccharides, such as lignin and pectin, significantly decreased the accessibility of cellulose in corncob and tomato peel, leading to unique products, such as carboxylated LNP and bulk carboxylated corncob and tomato peel MP with charge densities of up to 4 mmol g⁻¹. These results indicate that periodate-chlorite oxidation can provide a universal method to convert lignocellulosic biomass into sustainable biopolymeric micro- and nanomaterials with extremely high charge densities that are candidates for sustainable applications, such as water treatment and element recovery. As a proof-of-concept, carboxylated cotton MP was used for the removal and recovery of the critical REE, Nd³⁺, demonstrating a removal capacity of 92.5 mg g⁻¹ after only 5 min of contact and up to 64% recovery by altering the pH and taking advantage of the electrostatic nature of the adsorption. These findings demonstrate that the successive periodate-chlorite oxidation may be applied to widely available and sustainable lignocellulosic sources to yield new products bearing extremely high charge densities, beyond the theoretical values reported for cellulose nanocrystals. In addition, this study provides insights into the role of cellulose crystallinity and hemicellulose/lignin/pectin content on the oxidation of treated and untreated lignocelluloses and motivates further research on the conversion of raw materials to functional biomass-based colloids for sustainable development.

### REFERENCES

The following references are incorporated herein by reference in their entireties.
[1]J. Y. Zhu, U. P. Agarwal, P. N. Ciesielski, M. E. Himmel, R. Gao, Y. Deng, M. Morits, M. Österberg, Towards sustainable production and utilization of plant-biomass-based nanomaterials: a review and analysis of recent developments, Biotechnol. Biofuels. 14 (2021) 1-31. https://doi.org/10.1186/s13068-021-01963-5.
[2] X. Wu, N. Luo, S. Xie, H. Zhang, Q. Zhang, F. Wang, Y. Wang, Photocatalytic transformations of lignocellulosic biomass into chemicals, Chem. Soc. Rev. 49 (2020) 6198-6223. https://doi.org/10.1039/dOcs00314j.
[3] A. Zoghlami, G. Paës, Lignocellulosic Biomass: Understanding Recalcitrance and Predicting Hydrolysis, Front. Chem. 7 (2019) 1-11. https://doi.org/10.3389/fchem.2019.00874.
[4] B. Thomas, M. C. Raj, B. K. Athira, H. M. Rubiyah, J. Joy, A. Moores, G. L. Drisko, C. Sanchez, Nanocellulose, a Versatile Green Platform: From Biosources to Materials and Their Applications, Chem. Rev. 118 (2018) 11575-11625. https://doi.org/10.1021/acs.chemrev.7b00627.
[5]T. G. M. van de Ven, A. Sheikhi, Hairy cellulose nanocrystalloids: A novel class of nanocellulose, Nanoscale. 8 (2016) 15101-15114. https://doi.org/10.1039/c6nr01570k.
[6]J. Muthami, P. Wamea, M. Pitcher, M. N. Sakib, Z. Liu, S. Arora, D. Kennedy, Y.-J. Chang, A. Sheikhi, Hairy Cellulose Nanocrystals: Chemistry and Fundamentals, in: Cellul. Nanoparticles Chem. Fundam., 2021: pp. 1-36. https://doi.org/10.1039/9781788019521-00001.
[7]J. Muthami, P. Wamea, M. Pitcher, M. N. Sakib, Z. Liu, S. Arora, D. Kennedy, Y.-J. Chang, A. Sheikhi, Hairy Cellulose Nanocrystals: From Synthesis to Advanced Applications in the Water-Energy-Health-Food Nexus, in: Cellul. Nanoparticles Synth. Manuf., 2021: pp. 1-37.
[8]A. Sheikhi, T. G. M. van de Ven, Colloidal aspects of Janus-like hairy cellulose nanocrystalloids, Curr. Opin. Colloid Interface Sci. 29 (2017) 21-31. https://doi.org/10.1016/j.cocis.2017.02.001.
[9]H. Yang, M. N. Alam, T. G. M. van de Ven, Highly charged nanocrystalline cellulose and dicarboxylated cellulose from periodate and chlorite oxidized cellulose fibers, Cellulose. 20 (2013) 1865-1875. https://doi.org/10.1007/s10570-013-9966-7.
[10]D. Trache, M. H. Hussin, M. K. M. Haafiz, V. K. Thakur, Recent progress in cellulose nanocrystals: Sources and production, Nanoscale. 9 (2017) 1763-1786. https://doi.org/10.1039/c6nr09494e.
[11]H. Yang, D. Chen, T. G. M. van de Ven, Preparation and characterization of sterically stabilized nanocrystalline cellulose obtained by periodate oxidation of cellulose fibers, Cellulose. 22 (2015) 1743-1752. https://doi.org/10.1007/s10570-015-0584-4.
[12]E. Dalcanale, I. G. Donegani, F. Montanari, C. Cnr, C. Organica, I. Universita, Selective Oxidation of Aldehydes to Carboxylic Acids with Sodium Chlorite-Hydrogen Peroxide, 1 (1986) 567-569. https://doi.org/10.1021fjo00354a037.
[13]Z. Hosseinidoust, M. N. Alam, G. Sim, N. Tufenkji, T. G. M. van de Ven, Cellulose nanocrystals with tunable surface charge for nanomedicine, Nanoscale. 7 (2015) 16647-16657. https://doi.org/10.1039/c5nr02506k.
[14]N. Alipoormazandarani, T. Benselfelt, L. Wang, X. Wang, C. Xu, L. Wågberg, S. Willför, P. Fatehi, Functional Lignin Nanoparticles with Tunable Size and Surface Properties: Fabrication, Characterization, and Use in Layer-by-Layer Assembly, ACS Appl. Mater. Interfaces. 13 (2021) 26308-26317. https://doi.org/10.1021/acsami.1c03496.
[15]I. A. Gilca, V. I. Popa, C. Crestini, Obtaining lignin nanoparticles by sonication, Ultrason. Sonochem. 23 (2015) 369-375. https://doi.org/10.1016fj.ultsonch.2014.08.021.
[16]M. Lievonen, J. J. Valle-Delgado, M. L. Mattinen, E. L. Hult, K. Lintinen, M. A. Kostiainen, A. Paananen, G. R. Szilvay, H. Setälä, M. Österberg, A simple process for lignin nanoparticle preparation, Green Chem. 18 (2016) 1416-1422. https://doi.org/10.1039/c5gc01436k.
[17]H. Yang, A. Tejado, N. Alam, M. Antal, T. G. M. van de Ven, Films prepared from electrosterically stabilized nanocrystalline cellulose, Langmuir. 28 (2012) 7834-7842. https://doi.org/10.1021/la2049663.
[18]A. Sheikhi, H. Yang, M. N. Alam, T. G. M. van de Ven, Highly stable, functional hairy nanoparticles and biopolymers from wood fibers: Towards sustainable nanotechnology, J. Vis. Exp. 2016 (2016) 1-10. https://doi.org/10.3791/54133.
[19]J. G. Maltby, G. R. Primavesi, The estimation of aldehydes, ketones and acetals by means of the hydroxylamine hydrochloride method, Analyst. 74 (1949) 498-502. https://doi.org/10.1039/AN9497400498.
[20]L. Segal, J. J. Creely, A. E. Martin, C. M. Conrad, An Empirical Method for Estimating the Degree of Crystallinity of Native Cellulose Using the X-Ray Diffractometer, Text. Res. J. 29 (1959) 786-794. https://doi.org/10.1177/004051755902901003.
[21]S. Boufi, A. Chaker, Easy production of cellulose nanofibrils from corn stalk by a conventional high speed blender, Ind. Crops Prod. 93 (2016) 39-47. https://doi.org/10.1016/j.indcrop.2016.05.030.
[22]H. M. Rietveld, A profile refinement method for nuclear and magnetic structures, J. Appl. Crystallogr. 2 (1969) 65-71. https://doi.org/10.1107/s0021889869006558.
[23]M. Antlauf, N. Boulanger, L. Berglund, K. Oksman, O. Andersson, Thermal Conductivity of Cellulose Fibers in Different Size Scales and Densities, Biomacromolecules. 22 (2021) 3800-3809. https://doi.org/10.1021/acs.biomac.1c00643.
[24]Y. Wang, A. Kiziltas, A. R. Drews, S. Tamrakar, P. Blanchard, T. R. Walsh, Dynamical Water Ingress and Dissolution at the Amorphous-Crystalline Cellulose Interface, Biomacromolecules. 22 (2021) 3884-3891. https://doi.org/10.1021/acs.biomac.1c00690.
[25]P. Wamea, M. L. Pitcher, J. Muthami, A. Sheikhi, Nanoengineering cellulose for the selective removal of neodymium: Towards sustainable rare earth element recovery, Chem. Eng. J. 428 (2022) 131086. https://doi.org/10.1016/j.cej.2021.131086.
[26]T. K. Kim, T test as a parametric statistic, Korean J. Anesthesiol. 68 (2015) 540-546. https://doi.org/10.4324/9781315686875-6.
[27]M. Moradian, M. S. Islam, T. G. M. van de Ven, Insoluble Regenerated Cellulose Films Made from Mildly Carboxylated Dissolving and Kraft Pulps, Ind. Eng. Chem. Res. 60 (2021) 5385-5393. https://doi.org/10.1021/acs.iecr.1c00485.
[28] Whatman Qualitative Filter Paper, (2020) 2022. https://www.sigmaaldrich.com/U S/en/products/filtration/filter-paper #Whatman-Qualitative-Filter-Paper (accessed Feb. 16, 2022).
[29]A. Boonsombuti, A. Luengnaruemitchai, S. Wongkasemjit, Enhancement of enzymatic hydrolysis of corncob by microwave-assisted alkali pretreatment and its effect in morphology, Cellulose. 20 (2013) 1957-1966. https://doi.org/10.1007/s10570-013-9958-7.
[30]H. A. Silvério, W. P. Flauzino Neto, N. O. Dantas, D. Pasquini, Extraction and characterization of cellulose nanocrystals from corncob for application as reinforcing agent in nanocomposites, Ind. Crops Prod. 44 (2013) 427-436. https://doi.org/10.1016/j.indcrop.2012.10.014.
[31]M. Pointner, P. Kuttner, T. Obrlik, A. JAger, H. Kahr, Composition of corncobs as a substrate for fermentation of biofuels, Agron. Res. 12 (2014) 391-396.
[32]P. Brachi, F. Miccio, M. Miccio, G. Ruoppolo, Torrefaction of Tomato Peel Residues in a Fluidized Bed of Inert Particles and a Fixed-Bed Reactor, Energy and Fuels. 30 (2016) 4858-4868. https://doi.org/10.1021/acs.energyfuels.6b00328.
[33]G. Toscano, A. Pizzi, E. Foppa Pedretti, G. Rossini, G. Ciceri, G. Martignon, D. Duca, Torrefaction of tomato industry residues, Fuel. 143 (2015) 89-97. https://doi.org/10.1016/j.fuel.2014.11.039.
[34]P. Brachi, F. Miccio, M. Miccio, G. Ruoppolo, Pseudo-component thermal decomposition kinetics of tomato peels via isoconversional methods, Fuel Process. Technol. 154 (2016) 243-250. https://doi.org/10.1016/j.fuproc.2016.09.001.
[35]S. S. Claye, A. Idouraine, C. W. Weber, Extraction and fractionation of insoluble fiber from five fiber sources, Food Chem. 57 (1996) 305-310. https://doi.org/10.1016/0308-8146(95)00250-2.
[36]G. E. Anthon, J. V. Diaz, D. M. Barrett, Changes in pectins and product consistency during the concentration of tomato juice to paste, J. Agric. Food Chem. 56 (2008) 7100-7105. https://doi.org/10.1021/jf8008525.
[37]D. Chen, T. G. M. van de Ven, Morphological changes of sterically stabilized nanocrystalline cellulose after periodate oxidation, Cellulose. 23 (2016) 1051-1059. https://doi.org/10.1007/s10570-016-0862-9.
[38]H. Amer, T. Nypelö, I. Sulaeva, M. Bacher, U. Henniges, A. Potthast, T. Rosenau, Synthesis and Characterization of Periodate-Oxidized Polysaccharides: Dialdehyde Xylan (DAX), Biomacromolecules. 17 (2016) 2972-2980. https://doi.org/10.1021/acs.biomac.6b00777.
[39]B. Gupta, M. Tummalapalli, B. L. Deopura, M. S. Alam, Functionalization of pectin by periodate oxidation, Carbohydr. Polym. 98 (2013) 1160-1165. https://doi.org/10.1016/j.carbpol.2013.06.069.
[40]V. López Durán, P. A. Larsson, L. Wigberg, On the relationship between fibre composition and material properties following periodate oxidation and borohydride reduction of lignocellulosic fibres, Cellulose. 23 (2016) 3495-3510. https://doi.org/10.1007/s10570-016-1061-4.
[41]Y. Zhang, P. Fatehi, Periodate oxidation of carbohydrate-enriched hydrolysis lignin and its application as coagulant for aluminum oxide suspension, Ind. Crops Prod. 130 (2019) 81-95. https://doi.org/10.1016fj.indcrop.2018.12.052.
[42]R. J. A. Gosselink, J. E. G. Van Dam, E. De Jong, G. Gellerstedt, E. L. Scott, J. P. M. Sanders, Effect of periodate on lignin for wood adhesive application, Holzforschung. 65 (2011) 155-162. https://doi.org/10.1515/H F.2011.025.
[43]B. N. Brogdon, D. G. Mancosky, L. A. Lucia, New insights into lignin modification during chlorine dioxide bleaching sequences (I): Chlorine dioxide delignification, J. Wood Chem. Technol. 24 (2004) 201-219. https://doi.org/10.1081/WCT-200038082.
[44]A. Chaker, P. Mutje, M. R. Vilar, S. Boufi, Agriculture crop residues as a source for the production of nanofibrillated cellulose with low energy demand, Cellulose. 21 (2014) 4247-4259. https://doi.org/10.1007/s10570-014-0454-5.
[45]A. Chaker, S. Alila, P. Mutjé, M. R. Vilar, S. Boufi, Key role of the hemicellulose content and the cell morphology on the nanofibrillation effectiveness of cellulose pulps, Cellulose. 20 (2013) 2863-2875. https://doi.org/10.1007/s10570-013-0036-y.
[46]S. R. Djafari Petroudy, A. Ghasemian, H. Resalati, K. Syverud, G. Chinga-Carrasco, The effect of xylan on the fibrillation efficiency of DED bleached soda bagasse pulp and on nanopaper characteristics, Cellulose. 22 (2015) 385-395. https://doi.org/10.1007/sI0570-014-0504-z.
[47]J. Q. Wan, Y. Wang, Q. Xiao, Effects of hemicellulose removal on cellulose fiber structure and recycling characteristics of eucalyptus pulp, Bioresour. Technol. 101 (2010) 4577-4583. https://doi.org/10.1016fj.biortech.2010.01.026.
[48]A. T. W. M. Hendriks, G. Zeeman, Pretreatments to enhance the digestibility of lignocellulosic biomass, Bioresour. Technol. 100 (2009) 10-18. https://doi.org/10.1016/j.biortech.2008.05.027.
[49]Q. Liu, L. Luo, L. Zheng, Lignins: Biosynthesis and biological functions in plants, Int. J. Mol. Sci. 19 (2018). https://doi.org/10.3390/ijms19020335.
[50]H. Bian, L. Chen, H. Dai, J. Y. Zhu, Integrated production of lignin containing cellulose nanocrystals (LCNC) and nanofibrils (LCNF) using an easily recyclable di-carboxylic acid, Carbohydr. Polym. 167 (2017) 167-176. https://doi.org/10.1016/j.carbpol.2017.03.050.
[51]M. Delgado-Aguilar, I. Gonzilez, Q. Tarrés, M. A. Plach, M. Alcali, P. Mutje, The key role of lignin in the production of low-cost lignocellulosic nanofibres for papermaking applications, Ind. Crops Prod. 86 (2016) 295-300. https://doi.org/10.1016/j.indcrop.2016.04.010.
[52] Megawati, W. B. Sediawan, H. Sulistyo, M. Hidayat, Sulfuric acid hydrolysis of various lignocellulosic materials and its mixture in ethanol production, Biofuels. 6 (2015) 331-340. https://doi.org/10.1080/17597269.2015.1110774.
[53]D. H. Napper, Steric Stabilization, J. Colloid Interface Sci. 58 (1977) 390-407. https://doi.org/10.1016/b978-0-12-404501-9.50036-5.
[54]Z. Qian, K. A. I. Zhang, Recent Advances of Conjugated Microporous Polymers in Visible Light-Promoted Chemical Transformations, Sol. RRL. 5 (2021) 1-23. https://doi.org/10.1002/solr.202000489.
[55]D. J. Cosgrove, Diffuse growth of plant cell walls, Plant Physiol. 176 (2018) 16-27. https://doi.org/10.1104/pp. 17.01541.
[56]M. M. Mahmud, A. Perveen, R. A. Jahan, M. A. Matin, S. Y. Wong, X. Li, M. T. Arafat, Preparation of different polymorphs of cellulose from different acid hydrolysis medium, Int. J. Biol. Macromol. 130 (2019) 969-976. https://doi.org/10.1016/j.ijbiomac.2019.03.027.
[57]F. Jiang, Y. Lo Hsieh, Cellulose nanocrystal isolation from tomato peels and assembled nanofibers, Carbohydr. Polym. 122 (2015) 60-68. https://doi.org/10.1016/j.carbpol.2014.12.064.
[58]S. Park, J. O. Baker, M. E. Himmel, P. A. Parilla, D. K. Johnson, Cellulose crystallinity index: measurement techniques and their impact on interpreting cellulase performance, Biotechnol. Biofuels. 3 (2010) 1-10. https://doi.org/10.1080/02773818608085213.
[59]B. Ramirez, L. Bucio, Microcrystalline cellulose (MCC) analysis and quantitative phase analysis of ciprofloxacin/MCC mixtures by Rietveld XRD refinement with physically based background, Cellulose. 25 (2018) 2795-2815. https://doi.org/10.1007/s10570-018-1761-z.
[60]L. Van Hai, H. N. Son, Y. B. Seo, Physical and bio-composite properties of nanocrystalline cellulose from wood, cotton linters, cattail, and red algae, Cellulose. 22 (2015) 1789-1798. https://doi.org/10.1007/sI0570-015-0633-z.
[61]N. Farahbakhsh, P. S. Roodposhti, A. Ayoub, R. A. Venditti, J. S. Jur, Melt extrusion of polyethylene nanocomposites reinforced with nanofibrillated cellulose from cotton and wood sources, J. Appl. Polym. Sci. 132 (2015) 1-10. https://doi.org/10.1002/app.41857.
[62]S. Cichosz, A. Masek, I R study on cellulose with the varied moisture contents: Insight into the supramolecular structure, Materials (Basel). 13 (2020) 1-22. https://doi.org/10.3390/mal3204573.
[63]B. Tsegaye, C. Balomajumder, P. Roy, Biodelignification and hydrolysis of rice straw by novel bacteria isolated from wood feeding termite, 3 Biotech. 8 (2018) 1-11. https://doi.org/10.1007/s13205-018-1471-0.
[64]C. G. Boeriu, D. Bravo, R. J. A. Gosselink, J. E. G. Van Dam, Characterisation of structure-dependent functional properties of lignin with infrared spectroscopy, Ind. Crops Prod. 20 (2004) 205-218. https://doi.org/10.1016/j.indcrop.2004.04.022.
[65]U. P. Agarwal, S. A. Ralph, R. S. Reiner, C. G. Hunt, C. Baez, R. Ibach, K. C. Hirth, Production of high lignin-containing and lignin-free cellulose nanocrystals from wood, Cellulose. 25 (2018) 5791-5805. https://doi.org/10.1007/s10570-018-1984-z.
[66]H. Bian, L. Chen, R. Gleisner, H. Dai, J. Y. Zhu, Producing wood-based nanomaterials by rapid fractionation of wood at 80° C. using a recyclable acid hydrotrope, Green Chem. 19 (2017) 3370-3379. https://doi.org/10.1039/c7gc00669a.
[67]P. Segado, E. Dominguez, A. Heredia, Ultrastructure of the epidermal cell wall and cuticle of tomato fruit (Solanum lycopersicum L.) during development, Plant Physiol. 170 (2016) 935-946. https://doi.org/10.1104/pp. 15.01725.
[68]K. Binnemans, P. T. Jones, B. Blanpain, T. Van Gerven, Y. Yang, A. Walton, M. Buchert, Recycling of rare earths: A critical review, J. Clean. Prod. 51 (2013) 1-22. https://doi.org/10.1016/j.jclepro.2012.12.037.
[69]B. Sprecher, R. Kleijn, G. J. Kramer, Recycling potential of neodymium: The case of computer hard disk drives, Environ. Sci. Technol. 48 (2014) 9506-9513. https://doi.org/10.1021/es501572z.
[70]I. Anastopoulos, A. Bhatnagar, E. C. Lima, Adsorption of rare earth metals: A review of recent literature, J. Mol. Liq. 221 (2016) 954-962. https://doi.org/10.1016/j.molliq.2016.06.076.
[71]Z.-Y. Qin, G.-L. Tong, Y. C. F. Chin, J.-C. Zhou, Preparation of ultrasonic-assisted high carboxylate content cellulose nanocrystals by TEMPO oxidation, BioResources. 6 (2011) 1136-1146.
[72]J. A. Sirvió, M. Y. Ismail, K. Zhang, M. V. Tejesvi, A. Ámmälä, Transparent lignin-containing wood nanofiber films with U V-blocking, oxygen barrier, and anti-microbial properties, J. Mater. Chem. A. 8 (2020) 7935-7946. https://doi.org/10.1039/c9ta13182e.
[73]J. H. Jordan, M. W. Easson, B. D. Condon, Alkali hydrolysis of sulfated cellulose nanocrystals: Optimization of reaction conditions and tailored surface charge, Nanomaterials. 9 (2019). https://doi.org/10.3390/nano9091232.
[74]W. Qi, H. N. Xu, L. Zhang, The aggregation behavior of cellulose micro/nanoparticles in aqueous media, RSC Adv. 5 (2015) 8770-8777. https://doi.org/10.1039/c4ra08844a.

It should be understood that the disclosure of a range of values is a disclosure of every numerical value within that range, including the end points. It should also be appreciated that some components, features, and/or configurations may be described in connection with only one particular embodiment, but these same components, features, and/or configurations can be applied or used with many other embodiments and should be considered applicable to the other embodiments, unless stated otherwise or unless such a component, feature, and/or configuration is technically impossible to use with the other embodiment. Thus, the components, features, and/or configurations of the various embodiments can be combined together in any manner and such combinations are expressly contemplated and disclosed by this statement.

It will be apparent to those skilled in the art that numerous modifications and variations of the described examples and embodiments are possible considering the above teachings of the disclosure. The disclosed examples and embodiments are presented for purposes of illustration only. Other alternate embodiments may include some or all of the features disclosed herein. Therefore, it is the intent to cover all such modifications and alternate embodiments as may come within the true scope of this invention, which is to be given the full breadth thereof.

It should be understood that modifications to the embodiments disclosed herein can be made to meet a particular set of design criteria. Therefore, while certain exemplary embodiments of the apparatuses and methods of using and making the same disclosed herein have been discussed and illustrated, it is to be distinctly understood that the invention is not limited thereto but may be otherwise variously embodied and practiced within the scope of the following claims.

What is claimed is:

1. A method of forming a precipitate, the method comprising:
oxidizing a biomass with sodium periodate (NaIO₄) to convert a hydroxyl group of the biomass into an aldehyde group;
oxidizing the sodium periodate-oxidized biomass with sodium chlorite (NaClO₂) to convert the aldehyde group to a carboxylate group; and
forming a micro- and/or nano-structured precipitate with the sodium chlorite-oxidized biomass, the micro- and/or nano-structured precipitate having a charge density equal to or greater than 0.01 mmol g⁻¹.

2. The method of claim 1, wherein:
the micro- and/or nano-structured precipitate has a charge density equal to or less than 7.0 mmol g⁻¹.

3. The method of claim 2, wherein:
the charge density is due to the micro- and/or nano-structured precipitate including anionic groups with a concentration between a range of equal to or greater than 0.01 mmol g⁻¹ and equal to or less than 7.0 mmol g⁻¹.

4. The method of claim 1, wherein:
the biomass is a lignocellulosic material.

5. The method of claim 4, wherein:
the lignocellulosic material comprises softwood pulp, cotton, corncob, and/or tomato peel.

6. The method of claim 5, wherein:
NaIO₄ oxidation generates oxidative cleavage of vicinal diol at the C2-C3 bond on cellobiose.

7. The method of claim 6, wherein:
generating oxidative cleavage of vicinal diol breaks the C2-C3 bond while oxidizing the hydroxyl group.

8. The method of claim 1, wherein:
the micro- and/or nano-structured precipitate comprises micro- or nano-particles or micro- or nano-crystals.

9. The method of claim 1, further comprising:
quenching NaIO₄ oxidation.

10. The method of claim 9, wherein:
quenching the NaIO₄ oxidation by subjecting unreacted NaIO₄ to ethylene glycol.

11. The method of claim 1, wherein oxidizing the biomass with NaIO₄ forms a solid aldehyde-functionalized product, the method further comprising:
isolating the solid aldehyde-functionalized product via a filtering technique.

12. The method of claim 11, wherein:
oxidizing the sodium periodate-oxidized biomass with NaClO₂ involves subjecting the solid aldehyde-functionalized product to NaClO₂.

13. The method of claim 1, further comprising:
subjecting the sodium periodate-oxidized biomass to a hypochlorous acid (HOCl) scavenger during the step of oxidizing the sodium periodate-oxidized biomass with NaClO₂.

14. The method of claim 13, wherein:
the HOCl scavenger is hydrogen peroxide.

15. The method of claim 1, wherein:
forming the micro- and/or nano-structured precipitate involves centrifugation to isolate the precipitate.

16. The method of claim 15, wherein:
forming the micro- and/or nano-structured precipitate involves centrifugation and exposure to a poor solvent to isolate the precipitate.

17. The method of claim 16, wherein:
the poor solvent is EtOH.
